(19) United States
(12) Patent Application Publication
(10) Pub. No.: US 2004/0120221 A1
(43) Pub. Date: Jun. 24, 2004

(54) Hand position detecting apparatus and electronic timepiece using the same

(76) Inventors: Kenji Ogasawara, Chiba-shi (JP); Hideki Kitajima, Chiba-shi (JP)

Correspondence Address: ADAMS & WILKS, 31st Floor, 50 Broadway, New York, NY, 10004, US

(21) Appl. No.: 10/718,117

(22) Filed: Nov. 20, 2003

(30) Foreign Application Priority Data
Nov. 21, 2002 (JP) 2002-338291
Nov. 6, 2003 (JP) 2003-376713

(51) Int. Cl. G04B 19/06; G04B 19/04

(52) U.S. Cl. 368/80

(57) ABSTRACT

To provide a hand position detecting apparatus capable of accurately detecting that a hand reaches a predetermined position and an electronic timepiece using the same. A hand position detecting apparatus of a watch is provided with a light emitting element and a light receiving element as well as a reflection face to interpose an indictor wheel a rotational position of which is to be detected, there between, when an indicator wheel reaches a predetermined position, light from the light emitting element is made to be skewedly incident on the reflecting face via an opening for passing incident light of the indicator wheel, reflected light reflected skewedly by the reflecting face is detected by the light receiving element via an opening for passing the reflected light of the indicator wheel and the apparatus is provided with a rotational position detecting portion for detecting a rotational position at which a light receiving amount is maximized or a detectable time period of the output of the light receiving element becomes the shortest within a rotational range of the indicator having a light receiving amount equal to or higher than a minimum reference level by which the light receiving element can be regard to receive light from the light receiving element.

### BACKGROUND OF THE INVENTION

1. Field of the Invention

The present invention relates to a hand position detecting apparatus, a hand position setting apparatus and an electronic timepiece having the apparatus.

2. Description of the Prior Art

There is known a hand position detecting apparatus for detecting that a position of an indicator hand such as a second hand, a minute hand or an hour hand is temporarily returned to an initial position (for example, a correct position of 12 o'clock) in a timepiece having a radio wave correcting function for correcting time by receiving standard radio wave including time information and there is known the hand position detecting apparatus in which a light emitting element and a light receiving element as well as a reflecting face are arranged to interpose an indicator wheel a rotational position of which is to be detected and when the indicator wheel reaches a predetermined position, light from the light emitting element is made to be incident on the reflecting face via an opening of the indicator wheel and reflected light reflected by the reflecting face is detected by the light receiving element via an opening of the indicator wheel (for example, JP-A-200-35489 or Japanese Patent No. 2941576 (Patent Publication)). Further, it has been proposed that reflection by a predetermined reflecting face is detected by differentiating a case of receiving strong light reflected by the predetermined reflecting face from a case of receiving weak light reflected by a portion other than the predetermined reflecting face (JP-A-200-35489).

However, according to the hand position detecting apparatus of this kind having the reflecting face opposed to the light emitting portion and the light receiving portion, there is a concern that even when the indicator wheel is disposed at a position slightly deviated from the predetermined initial position, a portion of light emitted from the light emitting element is reflected by the predetermined reflecting face and is received by the light receiving element and when such light is received, there is a concern that the predetermined initial position cannot accurately be detected.

### SUMMARY OF THE INVENTION

The invention has been carried out in view of the above-described problem and it is an object thereof to provide a hand position detecting apparatus capable of accurately and stably detecting that an indicator hand reaches a predetermined position (target position) and an electronic timepiece using the same.

In order to achieve the above-described object, a hand position detecting apparatus of the invention is a hand position detecting apparatus for arranging a light emitting element and a light receiving element as well as a reflecting face to interpose an indicator wheel a rotational position of which is to be detected therebetween, making light from the light emitting element skewedly incident on the reflecting face via an opening of the indicator wheel for passing incident light when the indicator wheel reaches a predetermined position and detecting reflected light skewedly reflected by the reflecting face by the light receiving element via an opening of the indicator wheel for passing the reflected light, the hand position detecting apparatus comprising rotational position detecting means for detecting a rotational position maximizing a light receiving amount within a rotational range of the indicator wheel having the light receiving amount equal to or higher than a lowest reference level by which the light receiving element can be regarded to receive the light emitted from the light receiving element and reflected by the reflecting face.

The hand position detecting apparatus of the invention is provided with “rotational position detecting means for detecting a rotational position maximizing a light receiving amount within a rotational range of the indicator wheel having the light receiving amount equal to or higher than a lowest reference level by which the light receiving element can be regarded to receive the light emitted from the light receiving element and reflected by the reflecting face” and therefore, it can accurately be detected that the indicator wheel reaches a predetermined position or a target position, or reaches, for example, an initial position.

That is, according to the hand position detecting apparatus of the invention, particularly, “rotational position detecting means detects a rotational position maximizing a light receiving amount within a rotational range of the indicator wheel having the light receiving amount equal to or higher than a lowest reference level by which the light receiving element can be regarded to receive the light emitted from the light receiving element and reflected by the reflecting face” and therefore, the predetermined position (target position) at which light emitted from the light emitting element is maximally received by the light receiving element and a position slightly deviated from the predetermined position at which a portion of light emitted from the light emitting element reaches the light receiving element can be discriminated from each other and therefore, it can accurately be detected that the indicator wheel reaches the predetermined position.

In this case, the hand position detecting apparatus of the invention is particularly provided with “target position determining means for selecting a rotational position data in correspondence with a highest received light level in the received light level registered to the rotational position/received light level registering means as a target position data to register the data to the target position data registering means in a case in which at least one set of rotational position/received light level data is registered to the rotational position/received light level registering means and in which a determination stating that the light receiving amount at the light receiving element is smaller than the lowest reference level is carried out by the received light determining means” and therefore, a region at which the light receiving amount detected by the light receiving element substantially comprises a peak can be detected, the target position (predetermined position) at which light emitted from the light emitting element is maximally received by the light receiving element and a position at which a portion of light emitted from the light emitting element reaches the light receiving element, that is, a position slightly deviated from the target position (predetermined position) can be discriminated from each other and therefore, it can accurately be detected that the indicator wheel reaches the target position (predetermined position).

Further, in the specification, when there are a plurality of indicator wheels rotational positions of which are to be detected, the reflecting face arranged in combination with the light emitting element and the light receiving element “to interpose the indicator wheel the rotational position of which is to be detected therebetween” may be disposed to be more remote from the light emitting element and the light receiving element than the indicator wheel disposed most remote from the light emitting element and the light receiving element in the plurality of indicator wheels, or on a surface of the most remote indicator wheel opposed to the light emitting element and the light receiving element.

According to the hand position detecting apparatus of the invention, typically, the reflecting face is formed on a surface of a part selected from the group consisting of a second wheel, a minute wheel, an hour wheel and a train wheel moving these as well as a dial, a main plate and a train wheel bridge and a surface opposed to a circuit board or the like mounted with the light emitting element and the light receiving element. Here, the reflecting face may be formed by polishing or working at least a portion of the surface of the part, may be formed by adhering or depositing a reflecting film or a thin layer on the surface of the part, or may be formed by fixing a separate reflection mirror by adhering or the like. Further, the main plate represents a supporting member of various movable parts of a watch and when a middle frame or the like is used, regardless of the name, the middle frame or the like is included therein.

According to the hand position detecting apparatus of the invention, light from the light emitting element is made to be skewedly incident on the reflecting face and skewedly reflected by the reflecting face to be incident on the light receiving element and therefore, an optical path in a V-like shape is comprised as a whole, even when an interval or a thickness between a portion of the circuit board or the like mounting the light emitting element and the light receiving element and the reflecting face is comparatively small, an interval between the light emitting element and the light receiving element can be made to be comparatively large and therefore, a concern that the light receiving element receives astray light is inconsiderable. Further, an angle of incidence or an angle of reflection at the reflecting face is typically, for example, about 30 degrees. However, so far as light can be received by the light receiving element with a sufficient intensity, the angle may be, for example, about 45 degrees, about 60 degrees or higher depending on cases. Further, so far as there is not practically a concern that a portion of light emitted from the light emitting portion is reflected at a location other than a predetermined (original) reflecting face to be erroneously incident on the light receiving portion as the astray light, the angle of incidence or the angle of reflection may be smaller, for example, may be about 15 degrees or smaller.

According to the hand position detecting apparatus of the invention, typically, an opening for passing incident light and an opening for passing reflected light are separated by a partition wall portion. In this case, there is inconsiderable concern that incident light passing the opening for passing the incident light erroneously reaches the opening for passing the reflected light and therefore, a concern of receiving the astray light by the light receiving element can be minimized. However, when desired, in the indicator wheel the rotational position of which is to be detected, in at least a portion of indicator wheels, when there are a plurality of indicator wheels, an opening portion for forming the opening for passing the incident light and an opening portion for forming the opening for passing the reflected light may be comprised by one continuous slender opening. Further, even in the case of including one continuous slender opening as in an indicator wheel disposed to be proximate to the reflecting face, an indicator wheel disposed to be remote from the reflecting face typically includes two openings separated from each other.

In the hand position detecting apparatus of the invention, in order to avoid the size of the apparatus from being increased, a direction of separating the light emitting element and the light receiving element is comprised by a direction intersecting with a radius direction of the indicator wheel the rotational position of which is to be detected, typically, a direction orthogonal to the radius direction. In that case, in comparison with a diameter of a rotating part of a wheel or the like the interval between the opening for passing the incident light and the opening of passing the reflected light of the rotating member can be made to be large and therefore, the interval between the light emitting element and the light receiving element can be made to be comparatively large and the concern of receiving astray light by the light receiving element can be made to be inconsiderable. By making the direction of separating the light emitting element and the light receiving element by the direction intersecting with the radius direction of the indicator wheel the rotational position of which is to be detected, typically, the direction orthogonal to the radius direction, for example, when rotational positions of two wheels having rotational center axes in parallel with each other are simultaneously detected, the direction of connecting the light emitting element and the light receiving element is skewed (typically orthogonal) to a direction of connecting the rotational center axes of the two wheels, it is not necessary to arrange the light emitting element and the light receiving element between the two rotational center axes and therefore, the size of the rotational position detecting apparatus in a face orthogonal to the axial direction can be minimized.

According to the hand position detecting apparatus of the invention, the indicator wheel(s) include at least one of a second wheel, a minute wheel and an hour wheel, typically, include at least the minute wheel and the hour wheel and normally include the second wheel, the minute wheel and the hour wheel.

According to the hand position detecting apparatus of the invention, the rotational position detecting means typically comprises threshold level adjusting means for adjusting a threshold level by which the light receiving amount at the light receiving element is to be evaluated within a range of a plurality of reference levels having different magnitudes, received light determining means for determining whether the light receiving amount at the light receiving element is equal to or higher than the lowest reference level in the plurality of reference levels adjusted by the threshold level adjusting means each time at which the indicator wheel reaches a new rotational position, rotational position/received light level detecting means for determining which reference level in the plurality of reference levels adjusted by the threshold level adjusting means is lower than the light receiving amount when a determination stating that the light receiving amount at the light receiving element is equal to or higher than the lowest reference level is carried out by the received light determining means, and to register the result to rotational position/received light level registering means along with a rotational position data of the indicator wheel providing the light receiving amount, and target position determining means for selecting a rotational position data in correspondence with a highest received light level in the received light level registered to the rotational position/received light level registering means as a target position data to register the data to the target position data registering means in a case in which at least one set of rotational position/received light level data is registered to the rotational position/received light level registering means and in which a determination stating that the light receiving amount at the light receiving element is smaller than the lowest reference level is carried out by the received light determining means.

In this case, the hand position detecting apparatus of the invention is particularly provided with “target position determining means for selecting a rotational position data in correspondence with a highest received light level in the received light level registered to the rotational position/received light level registering means as a target position data to register the data to the target position data registering means in a case in which at least one set of rotational position/received light level data is registered to the rotational position/received light level registering means and in which a determination stating that the light receiving amount at the light receiving element is smaller than the lowest reference level is carried out by the received light determining means” and therefore, a region at which the light receiving amount detected by the light receiving element substantially comprises a peak can be detected, a target position (predetermined position) at which light emitted from the light emitting element is maximally received by the light receiving element and a position at which a portion of light emitted from the light emitting element reaches the light receiving element, that is, a position slightly deviated from the target position (predetermined position) can be discriminated from each other and therefore, it can accurately be detected that the indicator wheel reaches the target position (predetermined position).

Further, the hand position detecting apparatus is provided with “threshold level adjusting means for adjusting a threshold level by which a light receiving amount at the light receiving element is to be evaluated within a range of a plurality of reference levels having different magnitudes, received light determining means for determining whether the light receiving amount at the light receiving element is equal to or higher than a lowest reference level in the plurality of reference levels adjusted by the threshold level adjusting means each time at which the indicator wheel reaches a new rotational position, rotational position/received light level detecting means for determining which reference level in the plurality of reference levels adjusted by the threshold level adjusting means is lower than the light receiving amount when a determination stating that the light receiving amount at the light receiving element is equal to or higher than the lowest reference level is carried out by the received light determining means to register the result to the rotational position/received light level registering means along with a rotational position data of the indicator wheel providing the light receiving amount” and therefore, even when the light emitting element and the light receiving element are more or less deteriorated, so far as light equal to or higher than the lowest reference level can be detected by the light receiving element, regardless of a degree of deteriorating the light emitting element and the light receiving element, it can accurately be detected that the indicator wheel reaches the predetermined position.

Further, when there are a plurality of rotational positions in correspondence with the highest received light level, further positioning thereof is required. In order to be able to deal with such a case, according to the hand position detecting apparatus of the invention, the rotational position detecting means typically comprises threshold level adjusting means for adjusting a threshold level by which a light receiving amount at the light receiving element is to be evaluated within a range of a plurality of reference levels having different magnitudes, received light determining means for determining whether the light receiving amount at the light receiving element is equal to or higher than a lowest reference level in the plurality of reference levels adjusted by the threshold level adjusting means each time at which the indicator wheel reaches a new rotational position, rotational position/received light level detecting means for determining which reference level in the plurality of reference levels adjusted by the threshold level adjusting means is lower than the light receiving amount when a determination stating that the light receiving amount at the light receiving element is equal to or higher than the lowest reference level is carried out by the received light determining means to register the result to the rotational position/received light level registering means along with a rotational position data of the indicator wheel providing the light receiving amount, a highest received light level position number determining portion for determining a number of rotational position data in correspondence with a highest received light level in the received light levels registered to the rotational position/received light level registering means in a case in which at least one set of rotational position/received level data is registered to the rotational position/received light level registering means and in which a determination stating that the light receiving amount at the light receiving element is smaller than a lowest reference level, and storing positions of an upper limit and a lower limit in positions of a highest received light level to an upper limit lower limit position storing portion when the number is plural, reciprocal movement controlling means for driving indicator wheel driving means for reciprocally moving the indicator wheel within an angular range prescribed by the upper limit position and the lower limit position stored to the upper limit/lower limit position storing means, and designated target position data detecting means which is brought into a state of capable of receiving a position designating signal during the reciprocal movement and registers a position of the indicator at a time point of receiving the position designating signal to target position data registering means as a target position data.

In this case, even when there is a width in the peak region, setting of accurate position can swiftly be carried out.

Further, when there are a plurality of rotational positions in correspondence with the highest light receiving level, further positioning thereof is required. In order to be able to deal with such a case, according to the hand position detecting apparatus, the rotational position detecting means typically comprises threshold level adjusting means for adjusting a threshold level by which the light receiving amount at the light receiving element is to be evaluated within a range of a plurality of reference levels having different magnitudes, received light determining means for determining whether the light receiving amount at the light receiving element is equal to or higher than the lowest reference level in the plurality of reference levels adjusted by the threshold level adjusting means each time at which the indicator wheel reaches a new rotational position, rotational position received light level detecting means for determining which reference level in the plurality of reference levels adjusted by the threshold level adjusting means is lower than the light receiving amount is the light receiving amount when a determination stating that the light receiving amount at the light receiving element is equal to or higher than the lowest reference level is carried out by the received light determining means to register the result to rotational position/received light level registering means along with a rotational position data of the indicator wheel providing the light receiving amount, and target position determining means for selecting a rotational position data in correspondence with a highest received light level in the received light level registered to the rotational position/received light level registering means as a target position data to register the selected data to target position data registering means in a case in which at least one set of rotational position/received light level data is registered to the rotational position/received light level registering means and in which a determination stating that the light receiving amount at the light receiving element is smaller than the lowest reference level is carried out by the received light determining means.

The hand position detecting apparatus of the invention is a hand position detecting apparatus for arranging a light emitting element and a light receiving element as well as a reflecting face to interpose an indicator wheel a rotational position of which is to be detected therebetween, making light from the light emitting element skewedly incident on the reflecting face via an opening of the indicator wheel for passing incident light when the indicator wheel reaches a predetermined position and detecting reflected light skewedly reflected by the reflecting face by the light receiving element via an opening of the indicator wheel for passing the reflected light, the hand position detecting apparatus comprising rotational position detecting means for detecting a rotational position at which a time period of driving the light emitting element and a time period of detecting an output of the light receiving element become the shortest within a rotational range of the indicator wheel having a light receiving amount equal to or higher than a threshold level by which the light receiving element can be regarded to receive light emitted from the light emitting element and reflected by the reflecting face.

The hand position detecting apparatus of the invention is provided with “rotational position detecting means for detecting a rotational position at which a time period of driving the light emitting element and a time period of detecting an output of the light receiving element become the shortest within a rotational range of the indicator wheel having a light receiving amount equal to or higher than a threshold level by which the light receiving element can be regarded to receive light emitted from the light emitting element and reflected by the reflecting face”. According to the above-described method of determining which reference level of a plurality of reference levels adjusted by the threshold level adjusting means is lower than the light receiving amount of the light receiving element, the rotational position of the indicator wheel is detected by fixing the light emitting time period (light emitting amount) of the light emitting element and detecting the light receiving amount of the light receiving side, in sum, a variation in the output, however, even when a drive time period (light emitting amount) of the light emitting amount is changed and a determination reference of the light receiving amount is made to be constant, it can accurately be detected that the indicator wheel reaches the predetermined position or the target position, for example, reaches the initial position.

That is, according to the hand position detecting apparatus of the invention, particularly, “rotational position detecting means detects a rotational position at which a time period of driving the light emitting element and a time period of detecting an output of the light receiving element become the shortest within a rotational range of the indicator wheel having a light receiving amount equal to or higher than a threshold level by which the light receiving element can be regarded to receive light emitted from the light emitting element and reflected by the reflecting face” and therefore, it is important to stably detect a rate of the light receiving amount by the light receiving element to the light emitting amount from the light emitting element, in sum, a difference in a light receiving efficiency and the detection is an inherent object of the position detecting apparatus of the invention.

According to the hand position detecting apparatus of the invention, a magnitude of a threshold level by which the rotational position detecting means compares the light receiving amount of the light receiving element stays the same and the rotational position detecting means comprises means for changing a time period of driving the light receiving element, received light determining means for determining whether the output of the light receiving element is equal to or higher than the threshold level each time at which the indicator wheel reaches a new rotational position, rotational position/receivable detection time period storing means for determining which drive time period and detection time period in pluralities of drive time periods and detection time periods adjusted by means for changing a drive time period of the light emitting element and a detection time period of the output of the light emitting element to register the result to rotational position/receivable detection time period registering means along with a rotational positive data of the indicator wheel when a determination stating that the output of the light receiving element is equal to or higher than the threshold level is carried out by the received light determining means, and target position determining means for selecting a rotational position data in correspondence with a shortest detectable time period as a target position data to register the selected data to target position data registering means in the detectable time periods registered to the rotational position/receivable detection time period registering means in a case in which at least one set of rotational position/receivable detection time period data is registered in the rotational position/receivable time period registering means and in which a determination stating that the detection time period is set to be longest and the output of the light receiving element is smaller than the threshold level.

In this case, the hand position detecting apparatus of the invention is particularly provided with “target position determining means for selecting a rotational position data in correspondence with a shortest detectable time period as a target position data to register to target position data registering means in the detectable time periods registered to the rotational position/detectable time period registering means in a case in which at least one set of rotational position/detectable time period data is registered in the rotational position/detectable time period registering means and in which a determination stating that the detected time period is set to be longest and the output of the light receiving element is smaller than the threshold level” and therefore, the target position (predetermined position) at which light emitted from the light emitting element is maximally received by the light receiving element and the position at which a portion of light emitted from the light emitting element reaches the light receiving element, that is, a position slightly deviated from the target position (predetermined position) can be discriminated from each other and therefore, it can accurately be detected that the indicator wheel reaches the target position (predetermined position).

Further, the hand position detecting apparatus is provided with “means for adjusting a detection time period of an output of the light receiving element each time at which the indicator wheel reaches a new rotational position, received light determining means for determining whether the output of the light receiving element is equal to or higher than a threshold level and the rotational position/detectable time period detecting means for determining which detectable time period in a plurality of detectable time periods adjusted by the detection time period adjusting means is the shortest when a determination stating that the detection time period is set to be the longest and the output of the light receiving element is equal to or lower than the threshold level is carried out by the received light determining means to register the result to rotational position/detectable time period registering means along with a rotational position data of the indicator” and therefore, even when the characteristic of the light emitting element or the light receiving element is more or less varied, the variation can be dealt with by changing the timing of detecting the light receiving element and so far as the output of the light receiving element equal to or higher than the threshold level can be detected, regardless of the variation of the characteristic of the light emitting element or the light receiving element, it can accurately be detected that the indicator wheel reaches the predetermined position.

Further, when there are a plurality of rotational positions at which the detectable time period of the output of the light receiving element becomes the shortest, a further positioning thereof is required. In order to be able to deal with such a case, according to the hand position detecting apparatus of the invention, the rotational position detecting apparatus typically includes detection time period adjusting means of the light receiving element for adjusting a plurality of detectable time periods of the output of the light receiving element exceeding the threshold level within a constant range, received light determining means for setting the detection time period to be the longest and determining whether the output of the light receiving element is equal to or higher than the threshold level each time at which the indicator wheel reaches a new rotational position, rotational position/detectable time period setting means for determining which detectable time period is the shortest in a plurality of detectable time periods of the output of the light receiving element when a determination stating that the output of the light receiving element is equal to or higher than the threshold level is carried out by the received light determining means to register the result to rotational position/detectable time period registering means along with a rotational position data of the indicator wheel in correspondence with the detectable time period, shortest detectable time period position number determining means for determining the number of the rotational position data in correspondence with a shortest detectable time period in time periods registered to the rotational position/detectable time period in a case in which at least one set of rotational position/detectable time period is registered to the rotational position/detectable time period registering means and in which a determination stating that a detection time period of the output of the light receiving element is set to be the longest and the output is smaller than the threshold level is carried out by the received light determining means and, when the number is plural, storing positions of an upper limit and a lower limit in the shortest detectable time period to the upper limit/lower limit position storing portion, reciprocal movement controlling means for driving indicator wheel driving means for reciprocally moving the indicator wheel in an angular range prescribed by the upper limit position and the lower limit position stored to the upper limit/lower limit portion storing means, and designated target position data detecting means which is brought into a state of being capable of receiving the position designating signal during the reciprocal movement and registers a position of the indicator wheel at a time point of receiving the position designating signal to target position data registering means as target position data.

In this case, even when there is a width in the target position at which the detectable time period becomes the shortest, setting of accurate position can swiftly be carried out.

A hand position setting apparatus of the invention including the above-described hand position detecting apparatus typically includes indicator wheel driving means for incrementally rotating the indicator wheel and indicator wheel drive controlling means for driving the indicator wheel driving means for positioning the indicator wheel at a rotational position in correspondence with the predetermined position data.

In the above-described hand position setting apparatus, the indicator wheel driving means typically comprises a step motor for incrementally moving the indicator wheel. However, even when the motor is comprised by an analog motor of a type of continuously rotating the indicator wheel, the motor may be regarded to be moved incrementally substantially by dividing a rotational angle at each constant angle by sampling means.

### BRIEF DESCRIPTION OF THE SEVERAL VIEWS OF THE DRAWINGS

A preferred form of the present invention is illustrated in the accompanying drawings in which:

FIG. 1 is a schematic functional block diagram of a watch including a hand position setting apparatus having a hand position detecting apparatus of a preferable embodiment according to the invention;

FIG. 2 is a block diagram showing an outline of a hardware constitution of the watch of FIG. 1;

FIG. 3 illustrate explanatory views schematically showing initial position detecting operation of an optical detecting system of the watch of FIG. 1, FIG. 3A is an explanatory view of a section taken along a line IIIA-IIIA of FIG. 3B and FIG. 3B is an explanatory view of a section taken along a line IIIB-IIIB of FIG. 3A (explanatory view of plane section);

FIG. 4 illustrate explanatory views schematically showing a state of a detecting system of the optical detecting system of FIG. 3 when an indicator is disposed at a vicinity of the initial position, FIG. 4A is an explanatory view of a section taken along a line IVA-IVA of FIG. 4B and FIG. 4B is an explanatory view of a section taken along a line IVB-IVB of FIG. 4A (explanatory view of plane section);

FIG. 5 is a graph showing an example of indicator rotational position dependency of a detected output by a light receiving portion of the detecting system shown in FIG. 3;

FIG. 6 is a graph showing another example of the indicator rotational position dependency of the detected output by the light receiving portion of the detecting system shown in FIG. 3;

FIG. 7 is a plane explanatory view showing a case in which the indicator of the watch of FIG. 1 is disposed at the initial position;

FIG. 8 is a plane explanatory view for explaining operation for setting the indicator of the watch to the initial position when an output of the rotational position dependency as shown by FIG. 6 is provided;

FIG. 9 is a schematic circuit diagram showing an example of a circuit constitution of a light emitting portion, the light receiving portion and a received light level determining (detecting) portion in the hardware of FIG. 2;

FIG. 10 is a diagram showing a threshold level and a condition of generating the threshold level at a threshold level generating portion of the circuit of FIG. 9 by a style of a table;

FIG. 11 is a flowchart showing a flow of processings of the hand position setting apparatus including the hand position detecting apparatus of the preferable embodiment according to the invention;

FIG. 12 is a flowchart showing a flow of processings of a hand position setting apparatus including a hand position detecting apparatus of a preferable embodiment according to the invention;

FIG. 13 is a schematic functional block diagram of a watch having a hand position setting apparatus including a hand position detecting apparatus of other preferable embodiment according to the invention;

FIG. 14 is a graph showing an example of a voltage output characteristic by a light receiving portion of a detecting system shown in FIG. 13;

FIG. 15 is a flowchart showing a flow of processings of a hand position setting apparatus including a hand position detecting apparatus of other preferable embodiment according to the invention; and

FIG. 16 is a flowchart showing a flow of processings of a hand position setting apparatus including a hand position detecting apparatus of other preferable embodiment according to the invention.

### DETAILED DESCRIPTION OF THE PREFERRED EMBODIMENTS

Next, an explanation will be given of several preferred modes for carrying out the invention based on preferable embodiments shown in the attached drawings.

### Embodiment 1

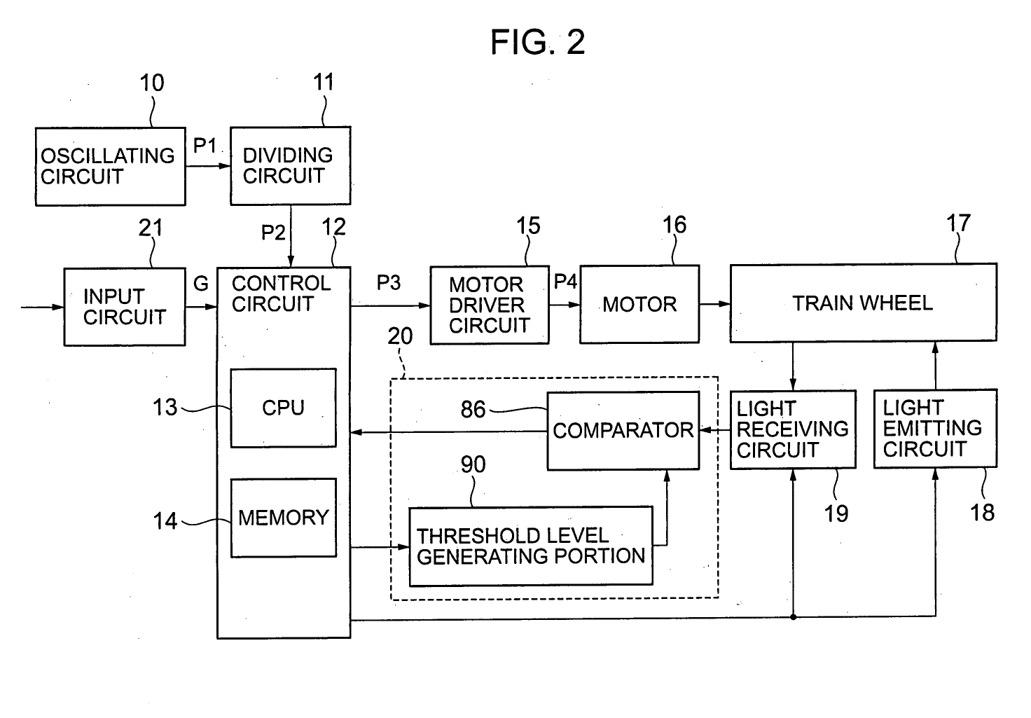

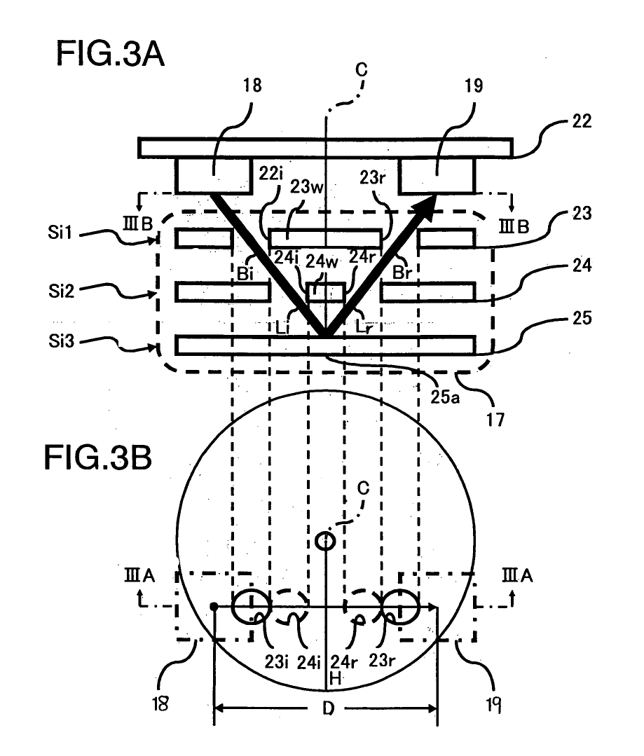

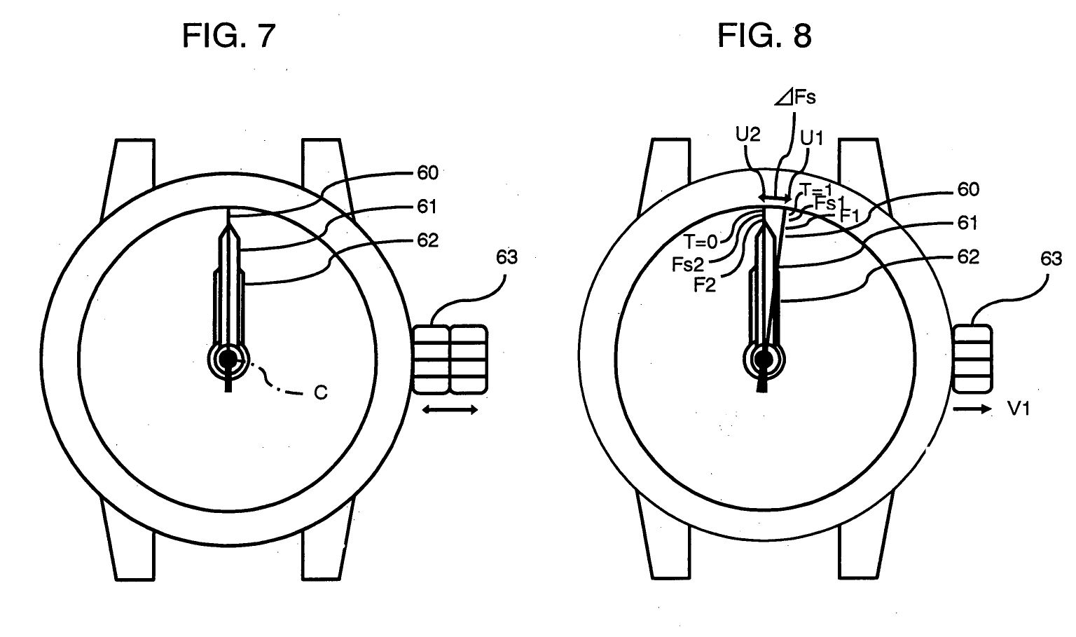

In a watch 1 of a preferable first embodiment according to the invention, as shown by FIG. 2, based on a pulse signal P2 comprised by dividing a signal P1 from an oscillating circuit 10 by a dividing circuit 11, a control circuit 12 including a microprocessor 13 and a memory 14 transmits a drive control signal P3 to a motor driver circuit 15 to rotate a motor 16 in accordance with a drive signal P4 by the motor drive circuit 15 and rotate a train wheel 17 brought in mesh to couple with an output shaft of the motor 16. Further, the train wheel 17 includes a middle train wheel and an indicator wheel of a second wheel 23, a minute wheel 24 or an hour wheel 25 (for example, FIG. 3). The second wheel 23, the minute wheel 24 and the hour wheel 25 are respectively attached with a second hand 60, a minute hand 61 and an hour hand 62 (for example, FIG. 7).

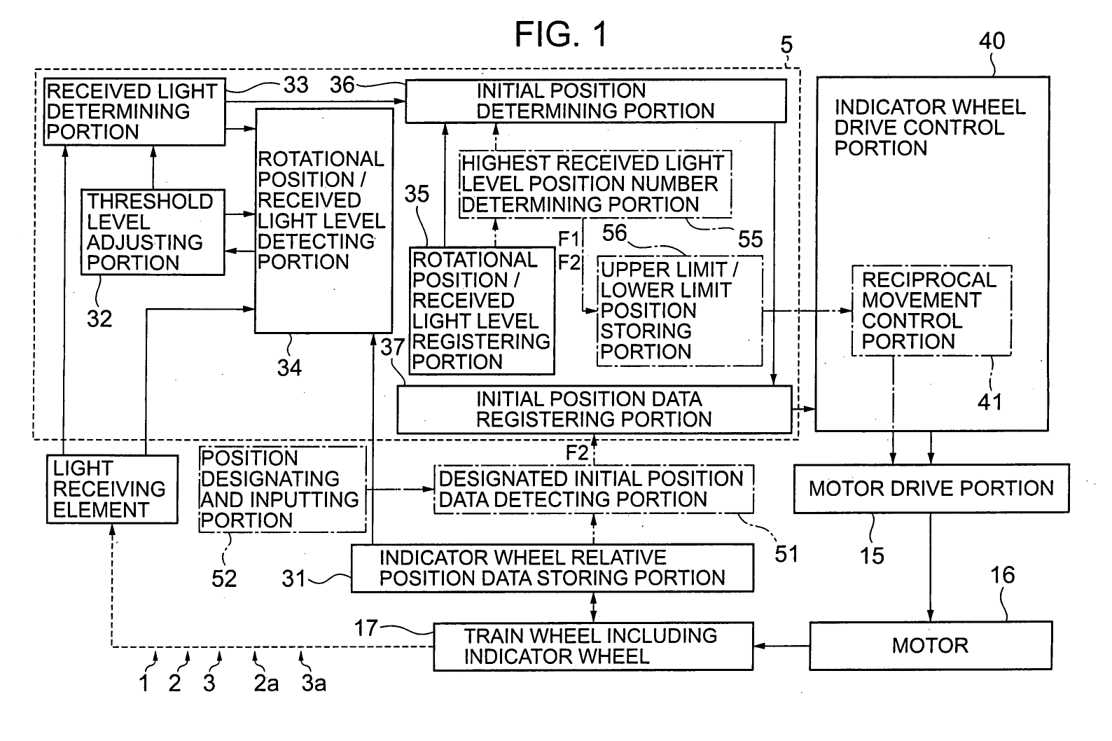

Further, as shown by FIG. 1, the memory 14 of the control circuit 12 is formed with an indicator wheel relative position data storing portion 31 for storing relative position data of the indicator wheel. The indicator wheel relative position data storing portion 31 comprises, for example, a counter for counting the number of the pulse signals P2 from the dividing circuit 11, in other words, a timer and count is increased one by one each time of receiving the pulse P2 by the control circuit 12. In the following, for simplifying the explanation, assume that the output pulse P2 from the dividing circuit 11 is a pulse having a repeating frequency of 1 Hz in normal hand operation and assume that at the indicator wheel relative position data storing portion 31, a count value N is increased one by one each time of advancing a position of the second hand 60 by an amount of one second, that is, one graduation. That is, in this case, assume that a reduction ratio between the output shaft of the motor 16 and the second wheel 23 is 1/30 and the second hand 60 is advanced by an amount of one second (rotated by 1/60) each time of rotating the motor 16 incrementally by half rotation.

When the watch 1 is operated, normally, the count value N of the indicator wheel relative position data storing portion 31 corresponds to rotational positions of the indicator wheels 23, 24 and 25 in a one-two-one relationship. However, when a battery is temporarily drawn, advancement of the hand is stopped by pulling out a crown 63 (FIG. 7), or by influence of an outside magnetic field, impact or the like, the relationship between the count value of the indicator wheel relative position data storing portion 31 and the rotational positions of the indicator wheels 23, 24 and 25 is not established. Therefore, in detecting the hand position, during a time period in which advancement of the hands 60, 61 and 62 is not stopped, an initial value is comprised by a count value N=Ns of the indicator wheel relative position data storing portion 31 at a time point of starting to detect the hand position in this example and the position of the indicator wheel and the count value are made to correspond to each other by an increment ΔN=N−Ns from an initial value.

It is detected as shown by FIG. 3 that the second wheel 23, the minute wheel 24 and the hour wheel 25 as indicator wheels are disposed at initial positions Si1, Si2 and Si3 as target positions (predetermined positions).

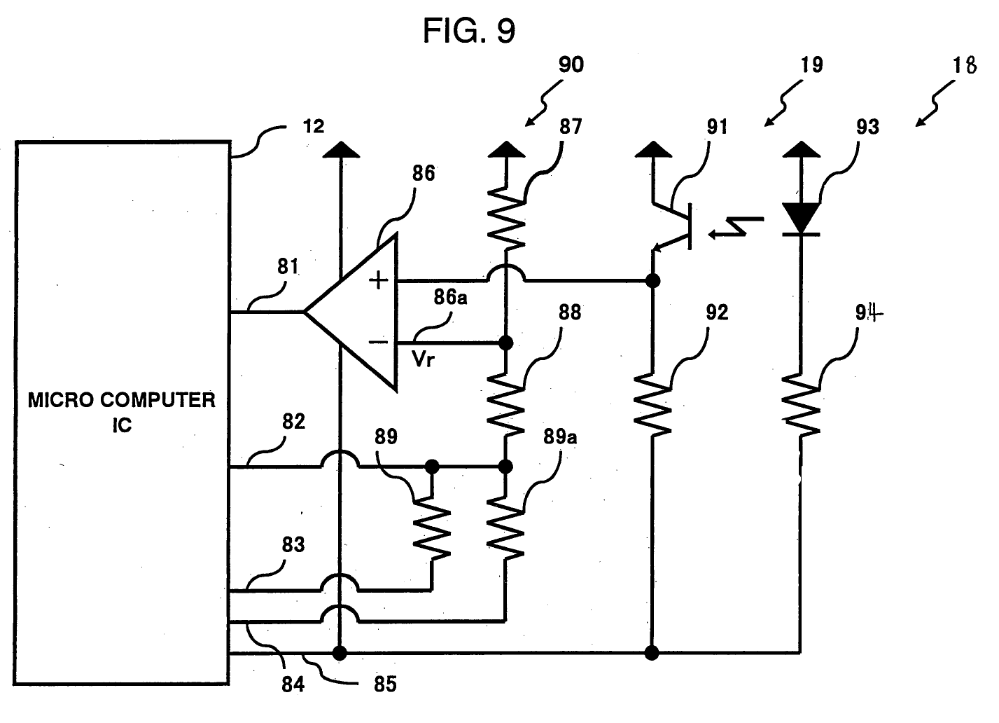

That is, as is known from FIG. 3A, for example, a circuit board 22 is mounted with a light emitting portion 18 including a light emitting element 93 (FIG. 9) such as LED and a light receiving portion 19 including a light receiving element 91 (FIG. 9) such as a phototransistor with an interval D therebetween and a reflecting face 25a is formed on a side of the hour wheel 25 opposed to the light emitting portion 18 and the light receiving portion 19 at a position for providing reflected light Br to the light receiving portion 19 by skewedly reflecting incident light Bi skewedly incident from the light emitting portion 18. Further, with respect to the second wheel 23 and the minute wheel 24, the second wheel 23 and the minute wheel 24 are separately formed with incident light passing openings 23i and 24i and reflected light passing openings 23r and 24r to open an incident optical path Li by which the incident light Bi from the light emitting portion 18 is correctly incident skewedly on the reflecting face 25a and open a light receiving optical path Lr by which the reflected light Br is emitted skewedly from the reflecting face 25a and is correctly incident on the light receiving portion 19 when all of the three indicator wheels 23, 24 and 25 are disposed at the initial positions Si1, Si2 and Si3 (at the correct position of 12 o'clock, hereinafter, the position is assumed to be the initial position).

Further, as is known from FIG. 3B, a direction of connecting the light emitting portion 18 and the light receiving portion 19, or a direction of extending a plane prescribed by the incident light optical path Li and reflected light optical path Lr, is a direction substantially orthogonal to a radius direction H in view from a plane view of FIG. 3B (plane orthogonal to rotational center axis line C). In other words, when the second wheel 23 and the minute wheel 24 are disposed respectively at the initial positions Si1 and Si2, a direction of connecting the incident light passing opening 23i and the reflected light passing opening 23r of the second wheel 23 and a direction of connecting the incident light passing opening 24i and the reflected light passing opening 24r of the minute wheel 24 are substantially orthogonal to the radius direction H. Here, it is assumed that the radius direction H is a direction of connecting middle points of a line connecting the openings 23i and 23r and a line connecting the openings 24i and 24r and the center axis line C.

Positional detection with high positional accuracy can be carried out by minimizing a thickness or a size of the watch 1 by arranging the light emitting portion 18 and the light receiving portion 19 as well as the reflecting face 25a to form an optical path in a V-like shape having a large opening angle by the incident light optical path Li and the reflected light optical path Lr and arranging the light emitting portion 18 and the light receiving portion 19 to align in a direction orthogonal to the radius direction H. Further, by separating the incident light passing openings 23i and 24i and the reflected light passing openings 23r and 24r via wall portions 23w and 24w, the separation serves to restrain a portion of the light Bi emitted from the light emitting portion 18 from being reflected at a location other than the reflecting face 25a to comprise astray-light to be incident on the light receiving portion 19 or promote resolution with respect to rotational angles of the indicator wheels 23 and 24.

Naturally, when desired, the reflecting face may be formed at a location other than the hour wheel 25, the incident light passing opening and the reflected light passing opening are comprised by a single continuous slender opening, or the direction of connecting the light emitting portion 18 and the light receiving portion 19 may not be orthogonal to the radius direction H but may intersect therewith skewedly by a smaller angle, or may be extended along the radius direction depending on cases such as the case of permitting a comparatively large-sized formation or the like.

In the above-described, in the case of the watch 1 such as a wrist watch, when sizes thereof are exemplified, an interval between the board 22 and the hour wheel 25 is about 2 through 3 mm, an interval between the light emitting element 93 (FIG. 9) of the light emitting portion 18 and the light receiving element 91 (FIG. 9) of the light receiving portion 19 is also about 2 through 3 mm, a size of the light emitting element 23 is about 0.3 mm □, a size of the light receiving element 91 is about 0.5 mm □ and any of a diameter or a length of each of the openings 23i and 23r, 24i and 24r is about 0.1 through 0.5 mm. However, the sizes may be larger or smaller.

Here, as shown by FIG. 7, at the initial positions Si1, Si2 and Si3 shown in FIGS. 3A and 3B, the second hand 60, the minute hand 61 and the hour hand 62 are disposed at correct positions of 12 o'clock.

In this way, when the second wheel 23, the minute wheel 24 and the hour wheel 25 are disposed at the initial positions Si1, Si2 and Si3, the light Bi from the light emitting portion 18 passes the optical paths Li and Lr and is correctly detected at the light receiving portion 19 as the reflected light Br and therefore, it is determined and detected that the second wheel 23 and the minute wheel 24 and the hour wheel 25 reach the initial positions Si1, Si2 and Si3 and positions of the second wheel 23, the minute wheel 24 and the hour wheel 25 are set to the initial positions Si1, Si2 and Si3.

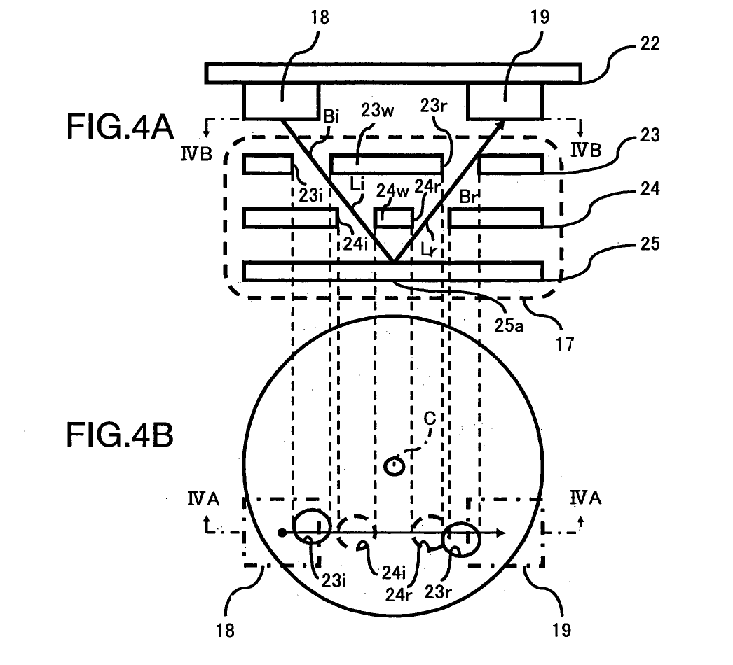

However, the openings 23i, 23r, 24i and 24r are provided with spreads to some degree, the reflecting face 25a is provided with a spread to some degree and therefore, even when the second wheel 23, the minute wheel 24 and the hour wheel 25 are not strictly disposed at the initial positions Si1, Si2 and Si3 and slightly deviated from the initial positions Si1, Si2 and Si3 as shown by FIGS. 4A and 4B, the incident light path Li and the reflection light path Lr partially remain and therefore, a possibility of receiving a portion of the light Bi from the light emitting portion 18 by the light receiving portion 19 as the reflected light Br is not inconsiderable.

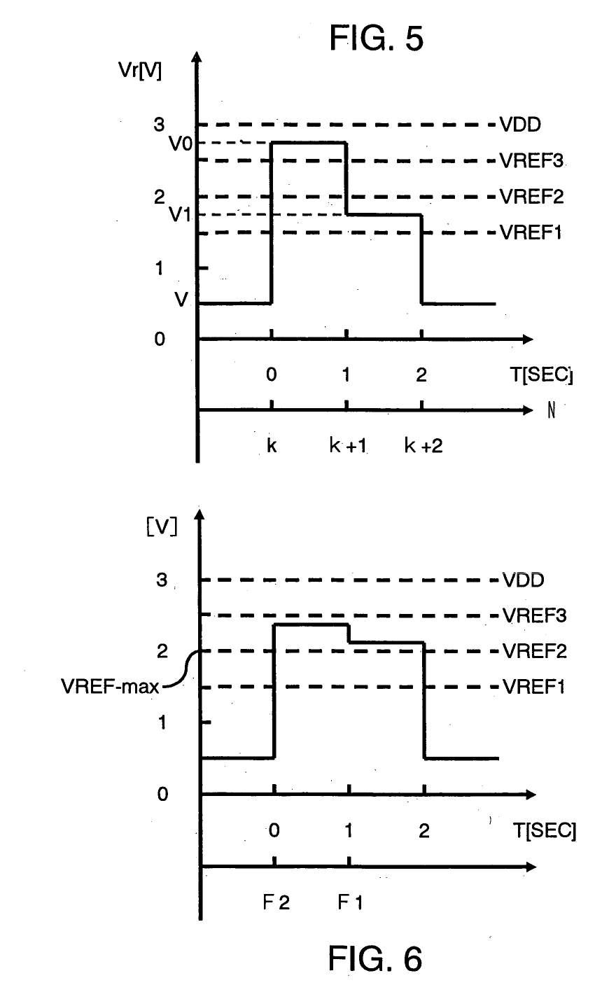

In that case, for example, an output Vr of the light receiving portion 19 in correspondence with a light receiving amount Ir at the light receiving portion 19 is as shown by FIG. 5. Here, the abscissa T designates time by a unit of second, in other words, rotational positions of the indicator wheels 23, 24 and 25 at one step by a unit of second. Further, as described, according to the example, the indicator wheel relative position data storing portion 31 counts the pulse by the unit of second. Therefore, the value of the abscissa T is brought into a relationship of T=N+δ or T=ΔN+δ with the count value N of the indicator wheel relative position data storing portion 31 operating as the timer or an increment ΔN thereof. Here, notation δ designates a constant integer value determined for each detecting operation of each time.

For example, whereas at a position T0 in correspondence with 0 second of FIG. 5 (initial position of FIG. 3), an output of Vr=V0 is provided from the light receiving portion 19, at a position T1 in correspondence with 1 second (a position slightly deviated from the initial position as shown by FIG. 4), there is a case of outputting an output Vr=V1 which is much higher than an output Vm at other position. Therefore, when the output Vr at the light receiving portion 19 is evaluated by constituting a threshold Vθ by a level as indicated by notation VREF1 in FIG. 5, there is a concern that the initial position T0 and the position T1 deviated from the initial position T0 by 1 second cannot be differentiated from each other.

In order to avoid such a concern, a hand position detecting apparatus 3 of a hand position setting apparatus 2 of the watch 1 is provided with a rotational position detecting apparatus 5 indicated in FIG. 1 by being surrounded by a broken line.

The rotational position detecting apparatus 5 is comprised by a threshold level variable comparator 20 including a comparator 86 for determining a received light level at the light receiving portion and a threshold level generating portion 90 for generating a plurality of kinds of threshold levels with a threshold level Vθ at the comparator 86, the control circuit 12 in a hardware mode including CPU 13 such as a microprocessor and the memory 14 and a computer program 70 stored in the memory 14. A portion of the memory 14 for storing the program 70 comprises a read only memory (ROM).

The apparatus 5 including the threshold level variable comparator 20 and realized when the program 70 is executed by CPU 13, includes a threshold level adjusting portion 32, a received light determining portion 33, a rotational position/received light level detecting position 34, a rotational position/received light level registering portion 35, an initial position determining portion 36 and an initial position data registering portion 37.

The threshold level adjusting portion 32 adjusts the threshold level Vθ by which the output Vr in correspondence with the light receiving amount Ir at the light receiving portion 19 is to be evaluated or compared within a range of a plurality of reference levels VREF1 through VREF3 having different magnitudes. The lowest reference level VREF1 is a lower limit capable of regarding that the light receiving portion 19 receives light emitted from the light emitting portion 18 and reflected by the reflecting face 25a and the highest reference level VREF3 is a level substantially equal to a level by which the light receiving portion 19 directly receives light from the light emitting portion 18, for example, an output voltage having a magnitude near to power source voltage. It may be determined as desired in how many stages an interval between the lowest reference level VREF1 and the highest reference level VREF3 is divided. For example, when the number of division stages is excessively small, as described later, there is a concern that the number of positions of levels constituting the highest level in a detection range is increased. Meanwhile, when the number of division stages is excessively large, there is a concern of requesting a wasteful time period in, for example, a detecting processing.

The received light determining portion 33 determines whether the output Vr in correspondence with the light receiving amount Ir at the light receiving portion 19 is equal to or higher than the lowest level VREF1 among the plurality of reference levels VREF1, VREF2 and VREF3 adjusted by the threshold level adjusting portion 32 each time at which the indicator wheels 23, 24 and 25 reach new rotational positions Ti.

When a determination stating that the output Vr in correspondence with the light receiving amount Ir at the light receiving portion 19 is equal to or higher than the lowest reference level VREF1 is carried out by the received light determining portion 33, the rotational position/received light level detecting portion 34 determines which reference level of the plurality of reference levels VREF1, VREF2 and VREF3 is lower than the output Vr in correspondence with the light receiving amount Ir and registers the determined level VREF1, VREF2 or VREF3 to the rotational position/received level registering portion 35 along with the rotational position data Ti of the indicator wheels 23, 24 and 25 providing the output Vr in correspondence with the light receiving amount Ir. Here, the rotational position data Ti of the indicator wheels 23, 24 and 25 are provided from the count value ΔN (or N) of the indicator wheel relative position data storing portion 31 as ΔN+δ.

In the case in which at least one set of the rotational position/received light level data (Tj, VREFj) is registered to the rotational position/received light level registering portion 35 and when a determination stating that the output Vr in correspondence with the light receiving amount Ir at the light receiving portion 19 is smaller than the lowest reference level VREF1 is carried out by the received light determining portion 33, the initial position determining portion 36 as target position determining means selects rotational position data Tj-max in correspondence with a highest received light level VREFj-max as initial position data from the received light level VREFj registered at the rotational position/received light level registering portion 35 to register the data to the initial position data registering portion 37. Here, the operation awaits for the determination stating that the output Vr in correspondence with the light receiving amount Ir at the light receiving portion 19 is smaller than the lowest reference level VREF1 carried out by the received light determining portion 33 for confirming or checking that detection at a vicinity of the initial position has been finished.

Explaining in details of an example of a specific circuit in reference to an example shown in FIG. 9, the light emitting portion 18 comprises, for example, the light emitting diode 93 and a current restricting resister 94 and the light receiving portion 19 comprises, for example, the phototransistor 91 and a light receiving sensitivity adjusting resistor 92.

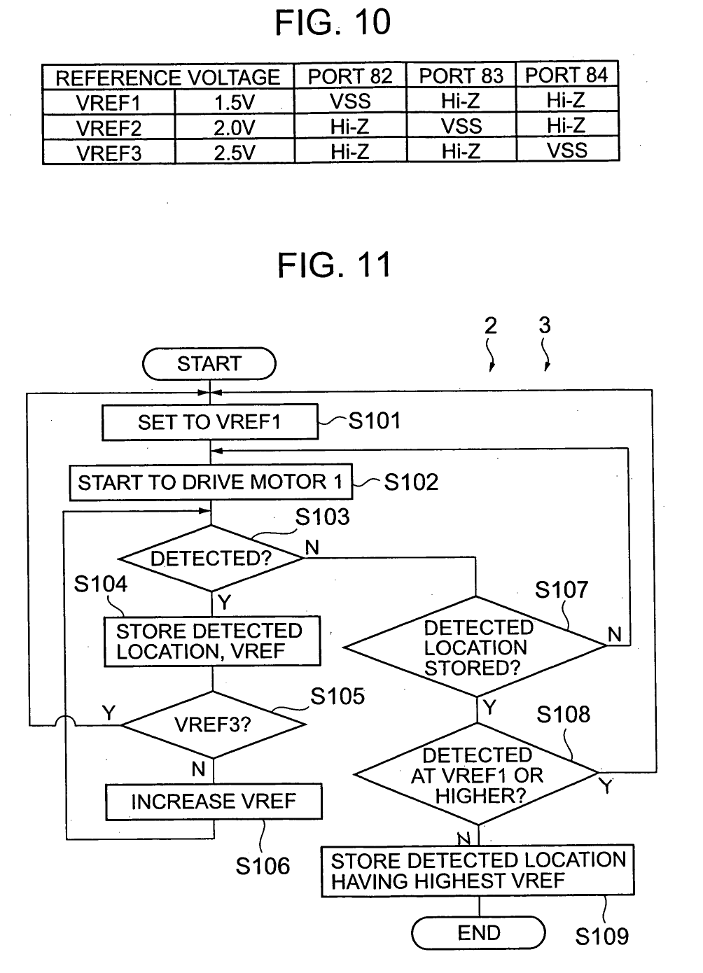

In the circuit of FIG. 9, a comparator 86 is used commonly in the received light determining portion 33 and the rotational position/received light level detecting portion 34, and a threshold level generating portion 90 in which resistors 87 and 88 and a register 89 or 89a are subjected to resistor division by a reference voltage inputting portion 86a and ports 82, 83, 84, comprise the threshold level adjusting portion 32 providing the reference levels VREF1, VREF2 and VREF3. According to the example, for example, power source voltage is 3V, resistance values of the resistors 87, 88 and 89 are equal to each other and a resistance value of the resistor 89a is four times as much as the resistance value. As shown by FIG. 10, threshold voltage Vθ applied on the reference voltage input portion 86a of the comparator 86 becomes the lowest reference voltage level VREF1 when the port 82 is set to low potential VSS and the ports 83 and 84 are substantially opened to set to high impedance Hi-Z, becomes the second reference voltage level VREF2 when the port 83 is set to low potential VSS and the ports 82 and 84 are substantially opened to set to high impedance Hi-Z and becomes the third (the highest in this example) reference voltage level VREF3 when the port 84 is set to low potential VSS and the ports 82 and 83 are substantially opened to set to high impedance Hi-Z.

Next, an explanation will be given of operation or manipulation of the hand position setting apparatus 2 having the hand position detecting apparatus 3 of the preferable embodiment according to the invention comprised as described above in reference to a flowchart of FIG. 11.

When an instruction stating to return hands 60, 61, 62 of the watch 1 to the correct initial position of 12 o'clock in radio wave correction or the like, the hand position detecting apparatus 3 per se is initialized and after the initialization, the watch 1 is brought into a forced zeroing mode.

In initializing the hand position detecting apparatus 3 per se, the port 82 of the control circuit portion of FIG. 9 is set to low level VSS, the ports 83 and 84 are opened to high impedance and the threshold level Vθ is set to the lowest reference level VREF1 (step S101 of FIG. 11). The lowest reference level VREF1 is a level for determining whether the light receiving portion 19 receives the light Br emitted from the light emitting portion 18 and reflected by the reflecting face 25a even partially and a level by which reception of noise light at a small light amount as in the case in which astray light is incident on the light receiving portion 19 is disregarded or cut off. That is, when a light receiving level equal to or higher than the lowest reference level VREF1 is comprised, it is guaranteed that the indicator wheels 23, 24 and 25 are disposed at initial positions or disposed to be proximate to the initial positions. Further, in the following, for simplifying explanation, assume that a content N of the indicator wheel relative position data storing portion 31 is reset to zero in the initialization. Here, when desired, the content N in resetting may be stored to other storing region to be able to reproduce the state in resetting.

Next, the watch 1 is brought into the forced zeroing mode. According to the forced zeroing mode, the repeating frequency of the pulse P2 from the dividing circuit 11 of FIG. 2 is increased to, for example, several tens times as much as that of the original frequency and the second hand 60 is forcibly rotated at high speed by about 1 rotation/second or by a far faster speed (step S102). Further, in starting to rotate the indicators 60, 61 and 62 by the forced zeroing mode, the content of the indicator wheel relative position data storing portion 31 is forcibly reset and therefore, positions of the indicators 60, 61 and 62 thereafter, in other words, positions of the indicator wheels 23, 24 and 25 correspond with the count value N of the indicator wheel relative position data storing portion 31 in the one-to-one relationship by constituting first position (original point) by a position at a time point of starting the zeroing operation.

In the forced zeroing mode, when a single one of the pulse P2 is outputted from the dividing circuit 11, the count value N of the indicator wheel relative position data storing portion 31 is incremented by “1”, the motor 16 is rotated by one step via the drive circuit 15, the second wheel 23 of the train wheel 17 is rotated by an amount of 1 second in accordance with incremental rotation of one step of the motor 16 and the minute wheel 24 coupled to the second wheel 23 via a train wheel and the hour wheel 25 coupled to the minute wheel 24 via a train wheel are rotated by an amount of 1 second.

In a state in which the indicator wheels 23, 24 and 25 of the train wheel 17 are rotated by the amount of 1 second in this way, it is compared by the comparing circuit 86 whether the output Vr in accordance with the light receiving amount Ir of the light receiving portion 19 is equal to or higher than the reference level VREF1 (step S103). Here, since the threshold Vθ is the lowest reference level VREF1, the processing at step S103 is carried out by the received light determining portion 33 of FIG. 1. Further, when the threshold level Vθ is equal to the reference level VREF2 or VREF3 higher than the lowest reference level VREF1, the processing at step S103 is carried out by the rotational position/received light level detecting portion 34 of FIG. 1.

In many cases, the indicator wheels 23, 24 and 25 are not disposed at a vicinity of the initial position immediately after starting the zeroing operation and therefore, Vr<VREF1 and therefore, in the flowchart of FIG. 11, the operation determines NO at step S103 and proceeds to step S107. At step S107, it is determined whether a location of detecting the light receiving amount output V equal to or higher than VREF1 is registered in the rotational position/received light level registering portion. In this case, since V≧VREF1 is not comprised yet, the operation determines NO at step S107, returns to step S102 and repeats to incrementally rotate the motor 16 by one step.

Although in view of hardware, after operation determines NO at step S107, the motor driver circuit 15 may be instructed to drive to output the drive pulse P4 to the motor 16, here, operation is carried out such that after finishing processing of steps S103 and S107 within a time period shorter than the repeating period of the pulse P2 from the dividing circuit 11, the control circuit 12 is brought into a standby state to await for input of successive pulse P2 and when the successive pulse P2 is received, the operation proceeds again to step S102.

Thereafter, until the indicator wheels 23, 24 and 25 become proximate the initial positions Si1, Si2 and Si3, it is repeated to rotate the motor 16 and the indicator wheels 23, 24 and 25 by an amount of 1 second at step S102, and determine or detect whether the output Vr of the light receiving amount at the light receiving portion 19 becomes equal to or higher than the minimum reference level VREF1 after the rotation (step S103) and return to step S102 by way of step S107 when the lowest reference level VREF1 is not reached. During the time period, the indicator wheels 23, 24 and 25 are rotated by the amount of 1 second and the count value N of the indicator wheel relative position data storing portion 31 is increased by an amount of corresponding seconds.

When the indicator wheels 23, 24 and 25 reach a vicinity of the initial position or the initial position by repeating incremental rotation of the motor 16, it is determined that V≧VREF1 is comprised by the received light determining portion 33 and therefore, the operation determines YES at step S103, proceeds to step S104, samples the current value N=k of the indicator wheel relative position data storing portion 31 as a rotational position, that is, a light receiving location at the time point, comprises one set of rotational position (light receiving location)/received light level data (k, VREF1) along with the threshold level VREF1 at that time and stores the data to the rotational position/received light level registering portion 35 of the memory 14.

Next, the operation proceeds to step S105 and checks whether the threshold level Vθ reaches the highest reference level VREF3 in correspondence with an output level in correspondence with a light amount provided by the light receiving portion 19 in the case in which the light emitting portion 18 and the light receiving portion 19 achieve substantially a maximum function and when the light receiving portion 19 is disposed at the initial position.

In this case, since Vθ=VREF1, the operation determines NO at the check step S105, proceeds to step S106, increase the threshold level Vθ by one stage from VREF1 to VREF2 and returns to step S103.

Here, it is assumed that a position of T=0 is reached in the case of providing the output Vr of the light receiving amount as shown by FIG. 5. Therefore, a determination of the light receiving amount Vr in the case of threshold Vθ=VREF2>VREF1 is carried out at the rotational position/the received light level detecting portion 34, and since V=Vk≧VREF2, the operation determines YES at step S103 and registers one set of the rotational position (light receiving location)/received light level data (k, VREF2) to the rotational position/received light level registering portion 35 at step S104. Although the rotational position/received light level data (k, VREF2), maybe registered to align with the preceding rotational position/received light level data (k, VREF1), typically, (k, VREF2) is overwritten on (k, VREF1) as more accurate data provided at the same rotational position, that is, the light receiving position k (the same as follows). At the time point, since Vθ=VREF2, the operation determines NO at successive step S105, proceeds to step S106, increases the threshold level Vθ by one stage from VREF2 to VREF3 and returns to step S103.

At T=0 of FIG. 5, the determination of the light receiving amount Vr in the case of threshold Vθ=VREF3>VREF1 is carried out again at the rotational position/received light level detecting portion 34 and since V=Vk≧VREF3, the operation determines YES again at the step S103 and registers one set of the rotational position/received light level data (k, VREF3) to the rotational position/received light level registering portion 35 at step S104. At this occasion, since the threshold level reaches the highest and Vθ=VREF3, at successive step S105, the operation passes through a branch of YES and returns to step S101. That is, the position k at which the received light level reaches the highest level VRREF3 is detected and registered, the operation proceeds to check the received light level at a successive rotational position. Here, the operation continues to check the received light level at the successive rotational position to confirm whether the rotational position (light receiving position) k is an intrinsic optimum position.

When the operation returns to step S101, the operation returns the threshold level Vθ to the lowest reference level VREF1, thereafter, rotates again the motor 16 and the indicator wheels 23, 24 and 25 by the amount of one second to set to a successive rotational position, increases the count value N of the indicator wheel relative position data storing portion 31 by the amount of one second to comprise N=k+1 (step S102) and determines or detects whether the output Vr of the light receiving amount at the light receiving portion 19 at the new rotational position k+1 is equal to or higher than the lowest reference level VREF1 (step S103).

In this case, by the incremental rotation of one step, a position of T=1 of the graph of FIG. 5 (in other words, position of N=k+1) is reached and as shown by FIG. 4, a portion of the light Bi from the light emitting portion 18 is reflected by the reflecting face 25a to reach the light receiving portion 19 and therefore, the detected output Vk+1 at the position of T=1 (that is, N=k+1) is higher than the lowest reference level VREF1.

Therefore, in the case of the example, the operation determines YES at step S103 and registers the rotational position/received light level data (k+1, VREF1) to the rotational position/received light level registering portion 35 at step S104.

Next, the operation proceeds to step S105, checks whether the threshold level Vθ reaches the highest reference level VREF3, determines NO at the check step S105 since Vθ=VREF1, proceeds to step S106, increases the threshold level Vθ by one stage from VREF1 to VREF2 and returns to step S103.

At this occasion, in the case of providing the output Vr of the light receiving amount as shown by FIG. 5, the position of T=1, that is, N=k+1 is reached, and therefore, since V=Vk+1<VREF2, the operation determines NO at step S103 in this case and proceeds to step S107.

Since the initial position or a vicinity thereof has already been reached and the detected record is registered at the rotational position/received light level registering portion 35, the operation determines YES at step S107 and proceeds to successive step S108.

At step S108, it is determined whether there is the significant received light level Vr equal to or higher than the lowest reference level VREF1 to dispose at a vicinity of the light receiving position or there is not the significant received light level Vr to deviate from the vicinity of the light receiving position and when disposed at the vicinity of the light receiving position, the detecting operation is further continued.

In the case of the example, at T=1, that is, the position N=k+1, since Vt≧VREF1, the operation determines YES at step S108, returns to step S101, returns the threshold level Vθ to the lowest reference level VREF1, rotates again the motor 16 and the indicator wheels 23, 24 and 25 by the amount of one second to set to successive rotational position N=k+2, increases the count value of the indicator wheel relative position data storing portion 31 by the amount of one second (step S102) and determines or detects whether the output V of the light receiving output amount at the light receiving portion 19 at new rotational position N=k+2 is equal to or higher than the lowest reference level VREF1 (step S103).

In this case, by the incremental rotation of one stage, a position of T=2, that is, N=k+2 of the graph of FIG. 5 is reached, the detected output Vk+1 at the position T=2 (N=k+2) is smaller than the lowest reference level VREF1 and the vicinity of the initial position has already been passed through.

Therefore, in the case of the example, the operation determines NO at step S103 and proceeds to step S107. Since the initial position or the vicinity has already been reached and the detected record is registered to the rotational position/received light registered portion 35, the operation determines YES at step S107 and proceeds to successive step S108.

At T=2, that is, position N=k+2, there is not the significant received light level Vr and passing the vicinity of the light receiving portion has been finished and therefore, the operation determines NO at step S108 and proceeds to step S109.

At step S109, a position of the highest level of the light receiving levels VREF3 and VREF1 registered at the rotational position/received light level registering portion 35 is determined to be VREF3 by the initial position determining portion 36, and the position of providing the highest level value VREF3 is determined to be at T=0, that is, N=k to register the result to the initial position data registering portion 37 as T=0 or N=k.

By registering that the initial position is T=0, that is, N=k to the initial position data registering portion 37 as described above, the initial position is ensured and therefore, by constituting a target position by the position in correspondence with the initial position, the indicator wheels 23, 24 and 25 are rotated to forcibly return to the initial position to position at the initial position by driving the motor 16 by the motor drive circuit 15 under control of the indicator wheel drive control portion 4d. In the rotation, in order to position in a short period of time, typically, the motor 16 is driven to rotate reversely by an amount of several seconds.

According to the watch 1 including the hand position setting apparatus 2 having the hand position detecting apparatus 3 as described above, the indicator wheels 23, 24 and 25 can accurately be positioned to the initial position by utilizing the fact that even when a portion of light emitted from the light emitting portion 18 is reflected by the reflecting face 25a and received by the light receiving portion 19 not only at the initial position of the indicator wheels 23, 24 and 25 but at a vicinity of the initial position deviated from the initial position, the light receiving amount is smaller than that at the initial position. Further, according to the watch 1 including the hand position setting apparatus 2 having the hand position detecting apparatus 3, when the vicinity of the initial position is temporarily reached, all of the surrounding is scanned, a peak is detected and when the detected output becomes smaller than the lowest reference level, the detecting operation is finished to position and therefore, it is not necessary to continue wasteful detecting operation.

Further, although in FIG. 5, only one light receiving pattern depending on the rotational position is assumed, it is apparent that even when tails are present on front and rear sides (left and right sides in FIG. 5) of a peak, a tail is present only on a front side (left side) of a peak, or a tail portion is not reduced monotonously but a maximum region smaller than a peak is present at the tail portion, so far as a peak sufficiently larger than other portion is disposed at one location, the peak can accurately be detected.

Meanwhile, when a peak is not sharp as shown by FIG. 5 but a width thereof is wide as shown by FIG. 6, there is a concern that the position of T=0 and the position of T=1 cannot be differentiated from each other. It is preferable to provide an additional function to the hand position detecting apparatus of the hand position setting apparatus of the watch such that the initial position can accurately be detected and the indicator can accurately be positioned to the initial position even in such a case.

An explanation will further be given of a hand position detecting apparatus having an additional peak identifying function further to the hand position detecting apparatus 3 as a hand position detecting apparatus 3a. In the hand position detecting apparatus 3a, a repeated explanation of portions thereof similar to those of the hand position detecting apparatus 3 will be omitted.

### Embodiment 2

A hand position setting apparatus 2a according to a second embodiment having the hand position detecting apparatus 3a includes not only the initial position determining position 36 but also a highest received light level position number determining portion 55, an upper limit/lower limit position storing portion 56, a reciprocal movement control portion 41, a designated initial position data detecting portion 51 as designated target position data detecting means and a position designating and inputting portion 52 between the rotational position/received light level registering portion 35 and the initial position data registering portion 37 as further shown by imaginary lines in FIG. 1.

In the case in which at least one set of the rotational position/received light level data is registered at the rotational position/received light level registering portion 35 and in which a determination stating that the output Vr of the light receiving amount at the light receiving portion 19 is smaller than the lowest reference level VREF1 is carried out by the received light determining portion 33, the highest received light level position number determining portion 55 determines a number Mmax of the rotational position data in correspondence with a highest received light level VREF-max in the received light levels registered in the rotational position/received light level registering portion 35 and, when the number Mmax is plural (equal to or larger than 2), stores positions F1 and F2 of an upper limit and a lower limit in the positions of the highest received light levels VRERF-max to the upper limit/lower limit position storing portion 56.

Further, the reciprocal movement control portion 41 drives the indicator wheel drive portion 15 to reciprocally move the indicator wheels 23, 24 and 25 within an angular range ΔF prescribed by the upper limit position F1 and the lower limit position F2 stored in the upper limit/lower limit position storing portion 56. Further specifically, the reciprocal movement control portion 41 reciprocally moves the second hand 60 and therefore, the second wheel 23 in U1 and U2 directions within an angular range ΔFs prescribed by an upper limit position Fs1 and a lower limit position Fs2 of the second hand 60 in correspondence with the upper limit position F1 and the lower limit position F2 stored to the upper limit/lower limit position storing portion 56. Further, naturally, the minute wheel 24 and the hour wheel 25 are also reciprocally moved in accordance with the reciprocal movement of the second wheel 23. The reciprocally moving control portion 41 comprises a portion of the indicator wheel drive control portion 40.

While the designated initial position data detecting portion includes an input circuit 21 (FIG. 2), is brought into a state of capable of receiving a position designating signal G in accordance with a displacement of the crown 63 (FIG. 8) connected to a winding stem (not illustrated) constituting the position designating and inputting portion 52 in a V1 direction during a time period of reciprocally moving the indicator wheels 23, 24 and 25 and registers positions of the indicator wheels 23, 24 and 25 at a time point of receiving the position designating signal G to the initial position data registering portion 37 as designated target position data, that is, designated initial position data Tg.

That is, in the case of the hand position detecting apparatus 3a of the hand position setting apparatus 2a, as shown by FIG. 8, the second hand 60 is slowly moved reciprocally in the directions of U1 and U2 between the positions Fs1 and Fs2, when a user pulls out the crown 63 in the V1 direction at a moment in which the second hand 60 correctly reaches 12 o'clock, the position designated signal G is outputted from the position designating and inputting portion 52 and a position of the second hand 60 (position Fs2 in the case of FIG. 8) at a time point of detecting the position designating the signal G as well as the position F2 of the minute hand 61 and the hour hand 62 are registered at the initial position data registering portion 37 as an initial position Tg.

Further, although by pulling out the crown 63 in the V1 direction, for example, the reciprocal movement of the second hand 60 may be made to stop, when the motor 16 is driven to rotate by way of the indicator wheel drive portion 15 in order to position the indicator wheels 23, 24 and 25 at the positions in correspondence with the initial position data F2 registered at the initial position data registering portion 37, the reciprocal movement of the indicator wheels 23, 24 and 25 may not be stopped by pulling out the crown 63.

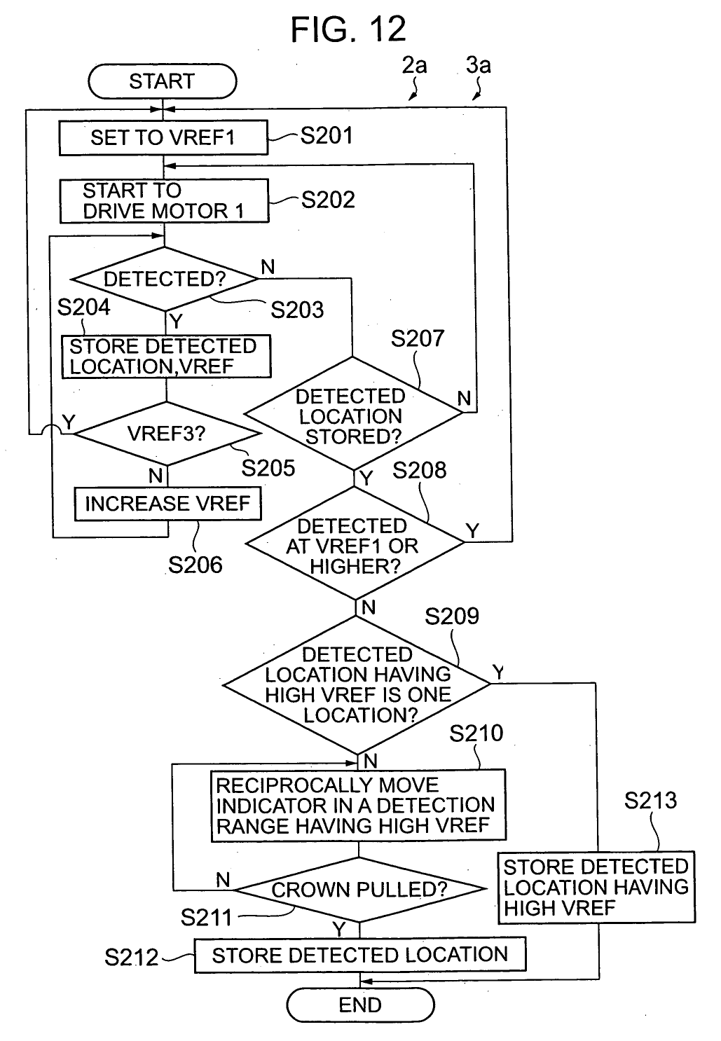

Next, an explanation will be given of manipulation and operation of the hand position setting apparatus 2a having the hand position detecting apparatus 3a comprised as described above in reference to a flowchart shown in FIG. 12.

In the flowchart of FIG. 12, steps S201 through S208 are the same as S101 through S108 of the flowchart of FIG. 11 and the operation stays to be the same as that in FIG. 11 until the operation determines NO at step S208 in correspondence with step S108, that is, until light from the light emitting portion 18 is detected by the light receiving portion 19 by the light amount equal to or higher than the lowest reference level VREF1 at the initial position and at the vicinity and thereafter, the operation determines that the light receiving amount at the light receiving portion 19 reaches to be smaller than the lowest reference level VREF1 by exceeding the vicinity region of the initial position.

However, according to the example, as is apparent from FIG. 6, the operation proceeds to step S209 in a state in which the rotational position/received light level registering portion 35 is stored with that the light receiving amount level at position T=0 is VREF2 and that the light receiving amount level at position T=1 is VREF2.

Here, since both of the light receiving amount levels at two locations of the light receiving positions of T=0 and T=1 are the same as VREF2 and the received light level VREF2 is the highest received light level VREF-max, a position at which the light receiving amount level becomes the highest is not uniquely determined and therefore, the operation proceeds to a selecting processing.

That is, at step S209, first, it is determined by the highest received light level position number determining portion 55 whether the location (position) of the highest light receiving amount level is only at one location. When the location is only at one location as a result of the determination, the operation determines YES at step S209 and proceeds to step S213. At step S213, the control is shifted from the highest received light level position number determining portion 55 to the initial position determining portion 36 and a processing similar to that at step S109 is carried out to finish the processing. The procedure in this case is the same as that in the case of the flowchart of FIG. 11.

However, in the case of the pattern shown by the graph of FIG. 6, the position of the highest received light level VREF-max=VREF2 is disposed at the plural locations T=0 and T=1 and therefore, the highest received light level position number determining portion 55 stores the lower limit position F2, that is, T=0 and the upper limit position F1, that is, T=1 in the plurality of continuous positions, in the lower limit/upper limit positioning storing potion 56, and the operation determines NO at step S209 and proceeds to step S210.

At step S210, under control of the reciprocal movement control portion 41, the indicators 23, 24 and 25 are reciprocally moved in the directions of U1 and U2 as shown by FIG. 8 between the lower limit and the upper limit positions F2 and F1 of the highest received light level VREF-max=VREF2 determined to be disposed at the plurality of locations at step S209, that is, the lower limit position F2, that is, T=0 and the upper limit position F1, that is, T=1 stored to the lower limit/upper limit position storing portion 56.

During the reciprocal movement, at the designated initial position data detecting position 51, it is checked whether the position designating signal G is inputted from the position designating and inputting portion 52, that is, in this example, whether the crown 63 is pulled in the V1 direction (step S211) The reciprocal movement step S210 and the check step 211 are continued until the crown 63 is pulled. That is, in this case, the position is finally determined by, for example, a user.

When the crown 63 is pulled in the V1 direction and the position designating signal G is provided to the designated initial position data detecting portion 51, the designated initial position data F2 is stored to the initial position data registering portion 37 (step S212).

The operation thereafter is similar to that in the case of the first embodiment.

As described above, according to the hand position setting apparatus 2a having the hand position detecting apparatus 3a shown by the flowchart of FIG. 12, by entrusting the final selection to the user, accurate detection and setting of the initial position can conveniently and swiftly be carried out. That is, when the initial position is intended to detect automatically and accurately without intervention of the user, it is necessary to extremely narrowing intervals between reference levels and provide a number of the reference levels to be able to identify small differences of the levels and there is a concern that a time period of processing required for determining the level of the light receiving amount is also prolonged, however, by acknowledging the intervention of the user, the concern can be avoided. Further, although according to the hand position setting apparatus 2a having the hand position detecting apparatus 3a shown by the flowchart of FIG. 12, the intervention of the user is requested, only single operation is requested for the user and therefore, excessive operation is not requested for the user and therefore, there is not practically a concern of deteriorating convenience of use by the user. Further, in entrusting the user, for the user, the determination can easily be carried out by optical recognition of the hand position and therefore, there poses no difficult problem when the user carries out the single operation. That is, according to the hand position setting apparatus 2a having the hand position detecting apparatus 3a shown by the flowchart of FIG. 12, while making full use of an advantage of automatic detecting system, the drawback of the detecting system is made to be able to be supplemented for by the advantage of the function of the person, a portion of entrusting to the person is narrowed to the minimum processing of optical recognition and designation capable of making full use of the advantage of the person such that the drawback of the function of the person does not pose a problem and therefore, accurate detection of the hand position and setting of the hand position can easily, firmly and swiftly be carried out.

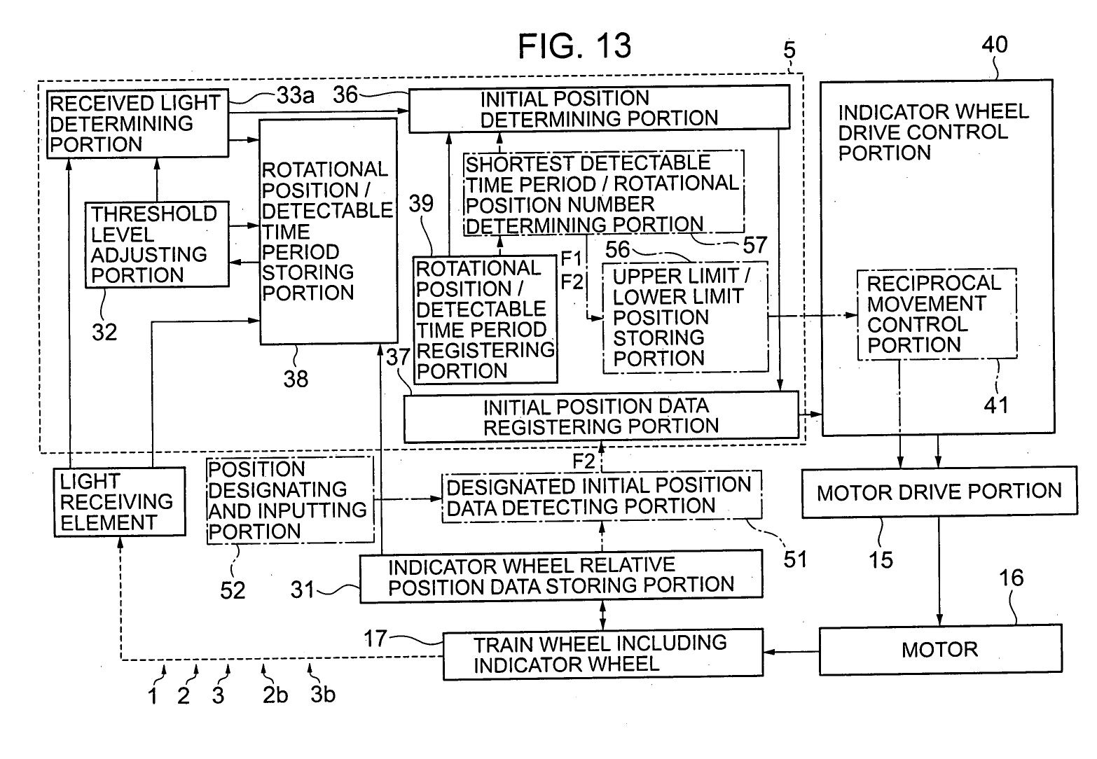

Next, an explanation will be given of a hand position detecting apparatus having a function of adjusting a timing of detecting the output of the light receiving element of the hand position detecting apparatus 3 as a hand position detecting apparatus 3b in reference to FIG. 13. In FIG. 13, in the hand position detecting apparatus 3b, a repeat explanation of portions similar to those of the hand position detecting apparatus 3 will be omitted.

### Embodiment 3

FIG. 13 shows a hand position setting apparatus 2b according to a third embodiment having the hand position detecting apparatus 3b. The hand position setting apparatus 2b according to the third embodiment having the hand position detecting apparatus 3b is provided with a rotational position/detectable time storing portion 38 in place of the rotational position/received light level detecting portion 34 of the hand position setting apparatus 2 according to the second embodiment shown by a bold line portion of FIG. 1. Further, the threshold level adjusting portion 32 is always adjusted to a constant level.

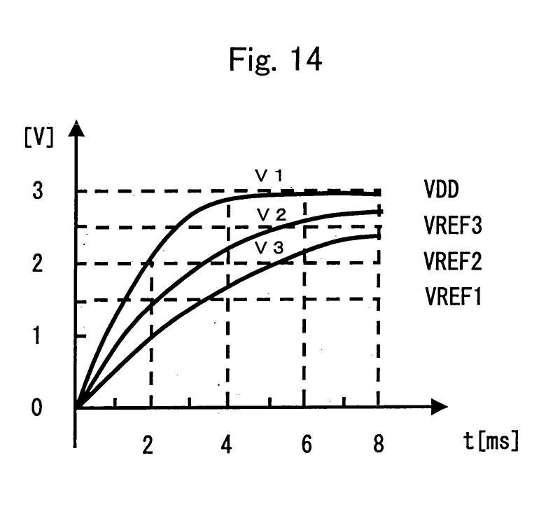

FIG. 14 shows a time characteristic of the output voltage of the light receiving element when light reaches the light receiving element from the light emitting element. The output voltage characteristic corresponds to large or small of the light amount reaching the light receiving element, the light amount is larger in an order of V1, V2 and V3 and the final output voltage is increased. According to the distribution, for example, in the case in which the standard level: VREF=2 is fixed as a threshold level, when a timing of detecting the output of the light receiving element at a received light determining portion 33b is designated by notation Tm, when Tm1 is set to 2 ms, only V1 can be detected. When Tm2 is similarly set to 4 ms, V1 and V2 can be detected and similarly, when Tm3 is set to 6 ms, V1, V2 and V3 can be detected.

Therefore, the function of detecting and registering the rotational position/received light level by switching the standard level constituting the threshold level can be replaced by the function of detecting and registering the rotational position and the output voltage of the light receiving element by switching the time period of driving the light emitting element and the timing of detecting the light receiving element.

### Embodiment 4

Further, a hand position setting apparatus 2c according to a fourth embodiment having a hand position detecting apparatus 3c designated by one-dotted chain lines is provided with a rotational position/detectable time registering portion 39 in place of the rotational position/received light level registering portion 35 of the hand position setting apparatus 2a according to the second embodiment shown by one-dotted chain lines of FIG. 1 and is provided with a shortest detectable time rotational position number determining portion 57 in place of the highest received light level position number determining portion 55. A point that the constitutions of the third embodiment and the fourth embodiment differ from the constitutions of the first embodiment and the second embodiment shown in FIG. 1 is limited to a portion of detecting, registering and determining the detectable time period in place of the received light level data. Also the limited portion is provided with substantially equivalent function.

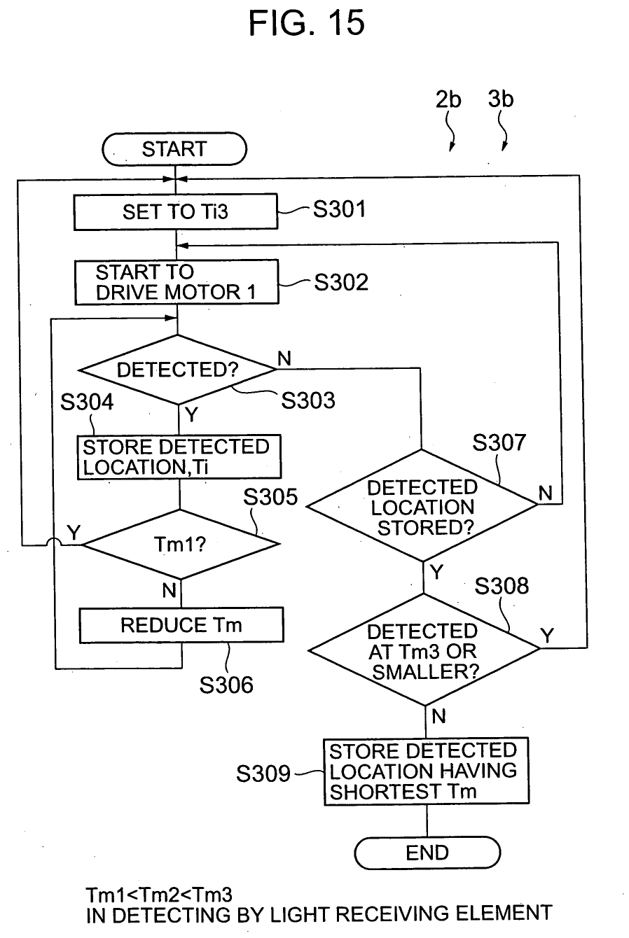

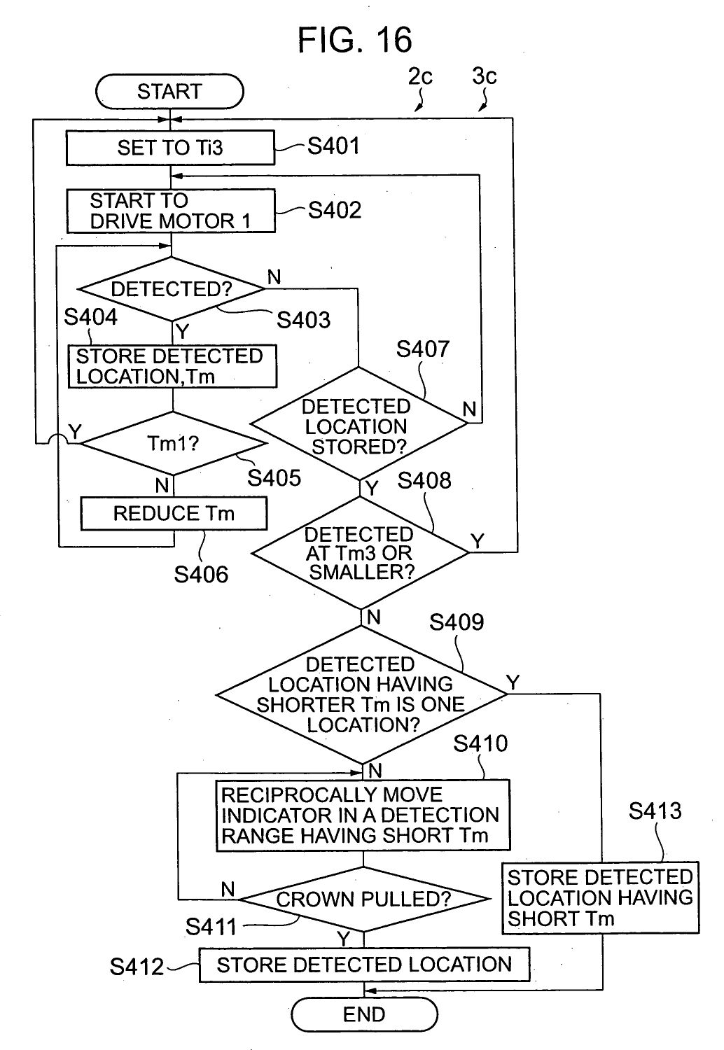

Therefore, although FIG. 15 and FIG. 16 shows flowcharts respectively showing operation of the third embodiment and the fourth embodiment, basically, processes thereof are similar to those of the flowcharts of the first embodiment and the second embodiment.

Further, according to the constitutions of the third embodiment and the fourth embodiment, by synchronizing time of finishing to drive the light emitting element to time of detecting the light receiving element, power consumption of the light emitting element can be restrained to necessary minimum. Further, according to the hand position detecting apparatus of the invention, timings and a number of times of detecting voltage of the light emitting element are not particularly limited. For example, it is also possible to detect voltage continuously at timings of 1 ms, 2 ms, 3 ms and 4 ms with time of starting to drive the light emitting element as a reference.

Further, in the constitutions of the third embodiment and the fourth embodiment according to the invention, even in a case in which the characteristics of the light emitting element and the light receiving element are changed by factors of dispersion or an ageing change, temperature or the like of part characteristics similar to the constitutions of the first embodiment and the second embodiment, the case can be dealt with by changing detection timings by a control circuit of a microcomputer or the like without using external resistors, switches or the like. Therefore, it is particularly advantageous in the case of the hand position detecting apparatus mounted to a watch necessitating low power consumption and small-sized formation.

According to the hand position detecting apparatus of the invention and the electronic timepiece using the same, even when a portion of light emitted from the light emitting portion is reflected by the reflecting face and received by the light receiving portion not only at the initial position of the indicator wheel but in the vicinity of the initial position deviated from the initial position, by utilizing the fact that the light receiving amount is smaller than that at the initial position, the indicator wheel can accurately be positioned to the initial position. According to the hand position detecting apparatus of the invention and the electronic timepiece using the same, when the vicinity of the initial position is temporarily reached, all of the surrounding is scanned, the peak is detected, the detecting operation is finished when the detected output becomes smaller than the lowest reference level, the positioning is carried out and therefore, it is not necessary to continue wasteful detecting operation.

Further, according to the hand position detecting apparatus of the invention and the electronic timepiece using the same, the hand position can easily be determined by the user by optical recognition, a portion entrusted to a person is narrowed to minimum recognizing and designating processing, making full use of advantage of the person and therefore, accurate detection of the position and setting of hand position can easily, firmly and swiftly be carried out.

Further, according to the hand position detecting apparatus of the invention and the electronic timepiece using the same, even when the characteristic of the light emitting element and the light receiving element is changed by the factor of dispersion, ageing change, temperature or the like of the part characteristic, the change can be dealt with by changing a detecting timing by a control circuit of a microcomputer or the like without using an external resistor, a switch or the like and therefore, low power consumption and small-sized formation can be achieved.

What is claimed is:

1. A hand position detecting apparatus for arranging a light emitting element and a light receiving element as well as a reflecting face to interpose an indicator wheel a rotational position of which is to be detected therebetween, making light from the light emitting element skewedly incident on the reflecting face via an opening of the indicator wheel for passing incident light when the indicator wheel reaches a predetermined position and detecting reflected light skewedly reflected by the reflecting face by the light receiving element via an opening of the indicator wheel for passing the reflected light, said hand position detecting apparatus comprising:
rotational position detecting means for detecting a rotational position maximizing a light receiving amount within a rotational range of the indicator wheel having the light receiving amount equal to or higher than a lowest reference level by which the light receiving element can be regarded to receive the light emitted from the light receiving element and reflected by the reflecting face.

2. A hand position detecting apparatus according to claim 1, wherein the rotational position detecting means comprises:
threshold level adjusting means for adjusting a threshold level by which the light receiving amount at the light receiving element is to be evaluated within a range of a plurality of reference levels having different magnitudes;
received light determining means for determining whether the light receiving amount at the light receiving element is equal to or higher than the lowest reference level in the plurality of reference levels adjusted by the threshold level adjusting means a teach time at which the indicator wheel reaches a new rotational position;
rotational position/received light level detecting means for determining which reference level in the plurality of reference levels adjusted by the threshold level adjusting means is lower than the light receiving amount when a determination stating that the light receiving amount at the light receiving element is equal to or higher than the lowest reference level is carried out by the received light determining means, and to register the result to rotational position/received light level registering means along with a rotational position data of the indicator wheel providing the light receiving amount; and
target position determining means for selecting a rotational position data in correspondence with a highest received light level in the received light level registered to the rotational position/received light level registering means as a target position data to register the data to the target position data registering means in a case in which at least one set of rotational position/received light level data is registered to the rotational position/received light level registering means and in which a determination stating that the light receiving amount at the light receiving element is smaller than the lowest reference level is carried out by the received light determining means.

3. A hand position detecting apparatus according to claim 1, wherein the rotational position detecting means comprises:
threshold level adjusting means for adjusting a threshold level by which a light receiving amount at the light receiving element is to be evaluated within a range of a plurality of reference levels having different magnitudes;
received light determining means for determining whether the light receiving amount at the light receiving element is equal to or higher than a lowest reference level in the plurality of reference levels adjusted by the threshold level adjusting means at each time at which the indicator wheel reaches a new rotational position;
rotational position/received light level detecting means for determining which reference level in the plurality of reference levels adjusted by the threshold level adjusting means is lower than the light receiving amount when a determination stating that the light receiving amount at the light receiving element is equal to or higher than the lowest reference level is carried out by the received light determining means, and to register the result to the rotational position/received light level registering means along with a rotational position data of the indicator wheel providing the light receiving amount;
a highest received light level position number determining portion for determining a number of rotational position data in correspondence with a highest received light level in the received light levels registered to the rotational position/received light level registering means in a case in which at least one set of rotational position/received level data is registered to the rotational position/received light level registering means and in which a determination stating that the light receiving amount at the light receiving element is smaller than a lowest reference level, and storing positions of an upper limit and a lower limit in positions of a highest received light level to an upper limit/lower limit position storing portion when the number is plural;
reciprocal movement controlling means for driving indicator wheel driving means for reciprocally moving the indicator wheel within an angular range prescribed by the upper limit position and the lower limit position stored to the upper limit/lower limit position storing means; and
designated target position data detecting means which is brought into a state of capable of receiving a position designating signal during the reciprocal movement and registers a position of the indicator at a time point of receiving the position designating signal to target position data registering means as a target position data.

4. A hand position setting apparatus including the hand position detecting apparatus according to claim 2, indicator wheel driving means for incrementally rotating the indicator wheel and indicator wheel drive controlling means for driving the indicator wheel driving means for positioning the indicator wheel at a rotational position in correspondence with the target position data registered to the target position data registering means.

5. A hand position setting apparatus including the hand position detecting apparatus according to claim 3, indicator wheel driving means for incrementally rotating the indicator wheel and indicator wheel drive controlling means for driving the indicator wheel driving means for positioning the indicator wheel at a rotational position in correspondence with the target position data registered to the target position data registering means.

6. An electronic time piece including the hand position setting apparatus according to claim 4.

7. An electronic timepiece including the hand position setting apparatus according to claim 5.

8. A hand position detecting apparatus according to claim 1, further comprising:
rotational position detecting means for detecting a time period of reaching the light receiving amount equal to or higher than a lowest reference level by which the light receiving element can be regarded to receive the light emitted from the light emitting element and reflected by the reflecting face.

9. A hand position detecting apparatus according to claim 1, wherein a magnitude of a threshold level by which the rotational position detecting means determines the light receiving amount of the light receiving element stays the same and the rotational position detecting means comprises:
means for changing a time period of detecting an output of the light receiving element;
received light determining means for determining whether the output of the light receiving element is equal to or higher than the threshold level each time at which the indicator wheel reaches a new rotational position;
rotational position/detectable time period registering means for determining by which detection time period in a plurality of detection time periods adjusted by means for adjusting the detection time period of the output of the light receiving element the rotational position is detectable when a determination stating that the output of the light receiving element is equal to or higher than the threshold level is carried out by the received light determining means and registering the detectable time period along with a rotational position data of the indicator wheel; and
target position determining means for selecting a rotational position data in correspondence with a shortest detectable time period as a target position data in the detectable time periods registered to the rotational position/detectable time period registering means to register the selected one to target position data registering means in a case in which at least one set of rotational position/detectable time period data is registered in the rotational position/detectable time period registering means and in which a determination stating that the detected time period is set to be longest and the output of the light receiving element is smaller than the threshold level.

10. A hand position detecting apparatus according to claim 1, wherein a magnitude of a threshold level by which the rotational position detecting means determines a light receiving amount of the light receiving element stays the same and the rotational position detecting means comprises:
means for adjusting a detection time period of the light receiving element;
received light determining means for setting the detection time period of the light receiving element by the detection time period adjusting means and determining whether the output of the light receiving element is equal to or higher than the threshold level each time at which the indicator wheel reaches a new rotational position;
rotational position/detectable time period registering means for determining which detection time period is the detection time period in a plurality of detection time periods adjusted by the detection time period adjusting means of the light receiving element when a determination stating that the output of the light receiving element is equal to or higher than the threshold level is carried out by the received light determining means and registering a detectable time period of the output of the light receiving element along with a rotational position data of the indicator wheel; and
target position determining means for constituting detection time period changing means for shortening the detectable time period of the output of the light receiving element in a case in which at least one set of rotational position/detectable time period data is registered in the rotational position/detectable time period registering means and in a case in which there are a plurality of locations of rotational positions at which the output of the light receiving element is equal to or higher than the threshold level and selecting a rotational position data in correspondence with a shortest detectable time period in the registered rotational position/detectable time periods as a target position data to register the selected data to target position data registering means.

11. A hand position detecting apparatus according to claim 8, further comprising means for controlling to drive the light emitting element synchronizing a timing of detecting the output of the light receiving element and time of finishing to drive the light emitting element.

12. A hand position detecting apparatus according to claim 9, further comprising means for controlling to drive the light emitting element synchronizing a timing of detecting the output of the light receiving element and time of finishing to drive the light emitting element.

13. A hand position detecting apparatus according to claim 10, further comprising means for controlling to drive the light emitting element synchronizing a timing of detecting the output of the light receiving element and time of finishing to drive the light emitting element.

14. A hand position setting apparatus including the hand position detecting apparatus according to claim 8, indicator wheel driving means for incrementally rotating the indicator wheel and indicator wheel drive controlling means for driving the indicator wheel driving means for positioning the indicator wheel to a rotational position in correspondence with a target position data registered in the target position data registering means.

15. A hand position setting apparatus including the hand position detecting apparatus according to claim 9, indicator wheel driving means for incrementally rotating the indicator wheel and indicator wheel drive controlling means for driving the indicator wheel driving means for positioning the indicator wheel to a rotational position in correspondence with a target position data registered in the target position data registering means.

16. A hand position setting apparatus including the hand position detecting apparatus according to claim 10, indicator wheel driving means for incrementally rotating the indicator wheel and indicator wheel drive controlling means for driving the indicator wheel driving means for positioning the indicator wheel to a rotational position in correspondence with a target position data registered in the target position data registering means.

17. A hand position setting apparatus including the hand position detecting apparatus according to claim 11, indicator wheel driving means for incrementally rotating the indicator wheel and indicator wheel drive controlling means for driving the indicator wheel driving means for positioning the indicator wheel to a rotational position in correspondence with a target position data registered in the target position data registering means.

18. A hand position setting apparatus including the hand position detecting apparatus according to claim 12, indicator wheel driving means for incrementally rotating the indicator wheel and indicator wheel drive controlling means for driving the indicator wheel driving means for positioning the indicator wheel to a rotational position in correspondence with a target position data registered in the target position data registering means.

19. A hand position setting apparatus including the hand position detecting apparatus according to claim 13, indicator wheel driving means for incrementally rotating the indicator wheel and indicator wheel drive controlling means for driving the indicator wheel driving means for positioning the indicator wheel to a rotational position in correspondence with a target position data registered in the target position data registering means.

20. An electronic timepiece including the hand position setting apparatus according to claim 14.

21. An electronic timepiece including the hand position setting apparatus according to claim 15.

22. An electronic timepiece including the hand position setting apparatus according to claim 16.

23. An electronic timepiece including the hand position setting apparatus according to claim 17.

24. An electronic timepiece including the hand position setting apparatus according to claim 18.

25. An electronic timepiece including the hand position setting apparatus according to claim 19.

26. A hand position detecting apparatus comprising:
an indicator wheel to be detected a rotational position;
a light emitting element to irradiate light to the indicator wheel;
a reflecting face to reflect the light;
a light receiving element to make light from the light emitting element skewedly incident on the reflecting face via an opening of the indicator wheel for passing incident light when the indicator wheel reaches a predetermined position and detecting reflected light skewedly reflected by the reflecting face by the light receiving element via an opening of the indicator wheel for passing the reflected light;
wherein the indicator wheel is arranged between the light emitting element, the light receiving element and the reflecting face; and
a rotational position detector to detect a rotational position maximizing a light receiving amount within a rotational range of the indicator wheel having the light receiving amount equal to or higher than a lowest reference level by which the light receiving element can be regarded to receive the light emitted from the light receiving element and reflected by the reflecting face.
